(19) United States
(12) Patent Application Publication
(10) Pub. No.: US 2012/0225449 A1
(43) Pub. Date: Sep. 6, 2012

(54) Method and appraratus utilizing enzyme substrates producing slow diffusing fluorescent product appearances and chromogens, and use in combination with fast diffusing product appearances

(76) Inventors: Geoffrey N. Roth, Goshen, IN (US); Jonathan N. Roth, Goshen, IN (US)

(21) Appl. No.: 13/199,419

(22) Filed: Aug. 30, 2011

Related U.S. Application Data
(63) Continuation-in-part of application No. 11/725,088, filed on Mar. 16, 2007, now Pat. No. 8,008,059.

(51) Int. Cl. G01N 21/64

(52) U.S. Cl. 435/34; 435/4

(57) ABSTRACT

A new method of rapid detection of cells, microorganisms, or other items is described using various combinations of indicator enzyme substrates which can yield fluorophoric and chromophoric appearances due to reaction with enzymes. An aspect of the invention is the use of a family of compounds producing both slow diffusing fluorophoric appearances and a family of compounds identified as dual enzyme substrates producing both fluorophoric and chromogenic appearances.

### CROSS REFERENCE TO RELATED APPLICATION

This application is a continuation in part of U.S. patent application Ser. No. 11/725,088, issued on Aug. 30, 2011 as U.S. Pat. No. 8,008,059. To the extent that the information herein differs substantively from the information presented in the parent patent application, that is the result of differences in the knowledge and/or understanding of that information and/or its applicability to the present invention between the dates of the respective application filings.

### BACKGROUND OF THE INVENTION

The present invention relates generally to methods and apparatus for detecting the presence of biological organisms and/or materials, and more particularly, for detecting the presence enzyme reactions through the use of indicator substrates. Enzyme substrates are often herein referred to as fluorogenic or chromogenic, based on the characteristics they demonstrate due to enzyme reaction, but it does not usually mean the substrates are fluorescent or chromogenic (colored). “Fluorogenic,” as used in this disclosure, means fluorescent except when describing a substrate. This definition may not apply to quoted material from references. For example, Manafi uses “substrate” to mean agar, and Indicator substrates may mean chromogenic or fluorogenic substrates or dual substrates. Chromogenic, fluorogenic and indicator substrates may be dual substrates.

Current biological assays, including microbial tests, are often non-quantitative in nature, which may pose definite problems in certain applications. Additional notable problems are the slowness of achieving results, and the high cost and limited availability of certain reagents used in various test formulations.

Substrates which, due to enzyme or other chemical reaction, provide for a new and/or more intense product appearance, have been used to indicate the presence of the enzymes or other reaction causing materials. Substrates so used can vary with the various assays to which they are applied, some being water based. Some have been used to detect aerobic, facultatively anaerobic, anaerobic, or microaerophilic organisms or other items. For example, some substrates (e.g.—chromogenic enzyme substrates or luminogenic enzyme substrates) allow (produce, provide, or provide for may in this document mean “allow”) due to enzyme reaction, detection of a chromogenic quality which may be detected as color, or which may be detected by instrumentation. As another example, some substrates (e.g.—fluorogenic) allow due to enzyme reaction, detection of a fluorescent quality that generally results from absorption of a light form (e.g.—ultraviolet light), and emission of some of the light at a different level that can be detected as color, or detected by instrumentation. These color detections are referred to herein by using terms including but not limited to “detections, detected appearances, product appearances, color, fluorescence, and qualities”. In the art prior to this and prior to the previous disclosure of this invention, few choices of types of appearances (qualities) were used. One was a quality that one expects to detect of a product that does not, in an aqueous environment, tend to precipitate much, if any, but tends to spread, diffuse, and is generally soluble. This type of quality often can spread and may be detected, in a solid microbial assay for instance, throughout the assay. This may be referred to in this disclosure as “fast diffusing”. In this disclosure “fast” may mean fast diffusing. A second quality is one that is expected of a product that, in an aqueous environment, tends to precipitate, but does not tend to spread, diffuse, and is generally insoluble. This type of quality may be referred to in this disclosure as “slow diffusing”. In this disclosure “slow” may mean slow diffusing. It may, due to its nature, tend to attach to or remain at least partly inside the item it identifies. This type of quality, (e.g.—in an agar or membrane filter microbial assays) can generally be detected in the near vicinity of a microbial colony, allowing the colony or more than one colony to be detected and enumerated. This may not be possible in the case of too many colonies to count. If an enzyme can move or is moved a distance from the item it identifies, the appearance it can provide, due to reaction with an indicator enzyme substrate, may mimic diffusion of a product appearance from an enzyme reaction site. This may be mistaken as a slow diffusing appearance. There may also be substrates that provide for intermediate qualities, but it is thought they tend toward one or the other. Some qualities due to enzyme substrates are affected by pH. Such substrates have been referred to as “pH-fluorescent indicators” in the art. One example is a methylumbelliferyl based substrate.

Indoxyl or indolyl based substrates indicate substrates, which, due to enzyme activity, are thought to allow for slow diffusing indigoid dyes. 3-indolyl-B-D-glucoside and bis-(5-br-4-cl-3-indoxy)-pyrophosphate are substrate examples reported to do this.

Methylumbelliferone or its derivatives which are produced often in alkaline conditions are both denoted by “methylumbelliferone, methylumbelliferyl or MU”. Common appearances provided for by MU (or nitrophenol compounds) are usually fast diffusing. Many examples describing substrate allowing for qualities due to enzyme reaction may use forms of the terms including but not limited to the following: (produce, fast, slow, fluorescent, chromogenic, color or quality”. For instance “producing slow fluorogenic qualities” uses forms of these terms. The above product appearances can be caused by non-enzymatic degradation of enzyme substrate, but in most cases and examples herein disclosed it is thought to be negligible if not stated otherwise. The following “Definitions” set forth are to be understood in light of the above explanations.

In recent years chromogenic, fluorogenic and other enzyme indicators have grown in favor for certain applications due to ease of use in enzyme assays for food, water, cancer, disease, tissue, enzyme and microbe research, and commerce in the biological area. Ley (U.S. Pat. No. 4,923,804) mentions that “5-bromo-4-chloroindoxy-.beta.-D-glucuronide . . . was disclosed by Pearson et al. in 1967 . . . ” regarding histochemistry. Ley then used an indolyl based substrate in microbial culture media. Edberg's U.S. Pat. No. 4,925,789 teaches a method for the use of one substrate producing a fast diffusing fluorescent quality MU substrate indicated due to enzyme reaction by fluorescent blue) for detection of beta-galactosidase, as well as one substrate producing a fast diffusing chromogenic quality (nitrophenol-yellow) for the detection of B-glucuronidase. This presence/absence test is in a broth and uses the substrates as a primary carbon source format, such as in the trademarked product Colilert. Quinazolinone based substrates (ELF-based substrates) are known in histochemistry and have been shown to work specifically with streaked agar methods in microbial assay art. These are used “filtered through a sterile syringe filter assembly to remove any undissolved impurities before adding to the cooled medium” (van Ommen Klocke, 1999). They have been added as a supplement after the medium has been sterilized. Haugland (U.S. Pat. Nos. 5,316,906 and 5,443,986) teaches immunohistochemical detection of enzyme activity with one “substrates made from a class of fluorophores, generally including quinazolinones (quinazolones), benzimidazoles, benzothiazoles, benzoxazoles, quinolines, indolines, and phenanthridines . . . ”. He uses a preferred substrate, 2-(5′-chloro-2′ phosphoryloxyphenyl)-6-chloroquinazolinone to detect enzyme activity. In his 1993 paper, he refers to “the phosphatase substrate 2-(5′-chloro-2′-phosphoryloxyphenyl)-6-chloro-4-[³H]-quinazolinone” as “CPPCQ” and in another publication quinazolinone based substrates are referred to as “ELF” substrates. This patent and paper do not specifically teach using or how to use this type of substrate in microbiological media. Another approach has been suggested using a fluorogenic enzyme substrate producing a fast fluorescent quality and also a chromogenic enzyme substrate producing a slow diffusing chromogenic quality with a solid assay. Brenner repeated this type of method using an inhibitor (see Brenner U.S. Pat. Nos. 6,063,590; 6,306,621; and 6,670,145).

Ley (U.S. Pat. No. 4,923,804) received a patent involving the use of indolyl-B-glucuronide to detect E. coli with membrane filtration. Further, Ferguson (U.S. Pat. No. 5,358,854) synthesized a novel chloroindolyl based substrate for Roth to use to detect coliforms, and Roth combined this with a bromo-chloro-indolyl based substrate to detect and differentiate E. coli and other coliforms. Roth (U.S. Pat. No. 5,210,022) taught the use of two contrasting slow diffusing chromogenic qualities, due to enzyme reactions with two chromogenic indolyl based substrates, to detect two different enzymes at once. Indolyl based substrates have been generally commercially available worldwide and generally accepted as non-toxic substrates that, due to enzyme reaction, provide for non-toxic detectable products. Comparative studies have been done which verified that the recovery of microbes in media containing indolyl based substrates are at least equivalent to the recovery of microbes in non indolyl based substrate-containing media. Many indolyl based substrates have been recommended for use by the Biosynth company, Ley, Manafi, Ferguson, Roth, Brenner, Dufour (by inclusion in patents and approvals for media given) and others. This is also generally true of fast diffusing nitrophenyl and methylumbelliferyl based substrates. The above teaching was done prior to the original disclosure of the invention to which this is a continuation in part.

However, the present invention can be well suited to replace the use of some prior substrates in enzyme assays, including above mentioned examples, where it may or may not be a main carbon source with or without other substrates, in a liquid or other form of an enzyme assay.

### SUMMARY OF THE INVENTION

The present invention provides methods and apparatus that can be used for detecting items by using enzyme substrates producing a slow fluorescent quality, sometimes in combination with enzyme substrates which can produce a fast color quality used to detect said items. This invention provides, at least in part, novel use of indicator enzyme substrates to detect enzyme reaction for oncology, disease, tissue, enzyme and microbe, and other biological item research and commerce related to the biological areas and has application in the detection of such items as organisms, through the use of fluorogenic or chromogenic enzyme substrates

One embodiment makes use of an absorbent pad or gel as a base onto which at one side a diagnostic material of at least one of a fluorogenic or chromogenic quality is placed. A sample which may contain a specific target item, such as an enzyme or microbe, is applied to the diagnostic material which can produce for a color quality indicating the presence of the target item. UV and visible light may be used to view both sides of the pad or gel to detect any fluorescent and chromogenic qualities representing the target item/items. In another embodiment, the base can be an absorbent device, such as one of various gelling agents. In this case a pad may be unnecessary.

In another embodiment, the diagnostic material is a substrate that can produce both a fluorescent and chromogenic quality at one side of the base, used to detect target items, e.g., enzyme activity. The base can be an absorbent device, such as one or more gelling agents of various types. It is an object of this invention to provide a method of detecting specific items/enzyme activity/organisms in rapid fashion.

If gelling agents are used, a pad may be unnecessary.

In general, an object of this invention is to provide a method of microbial testing which is economical and provides accurate results.

Other objects will become readily apparent to those skilled in the art as a result of the following additional description.

### BRIEF DESCRIPTION OF THE DRAWINGS

The patent or application file contains at least one drawing/photograph executed in color. Copies of this patent or published patent application with color drawing(s)/photograph(s) will be provided by the Office upon request and payment of the necessary fee.

FIG. 1 is diagrammatic view of a test container used in this invention;

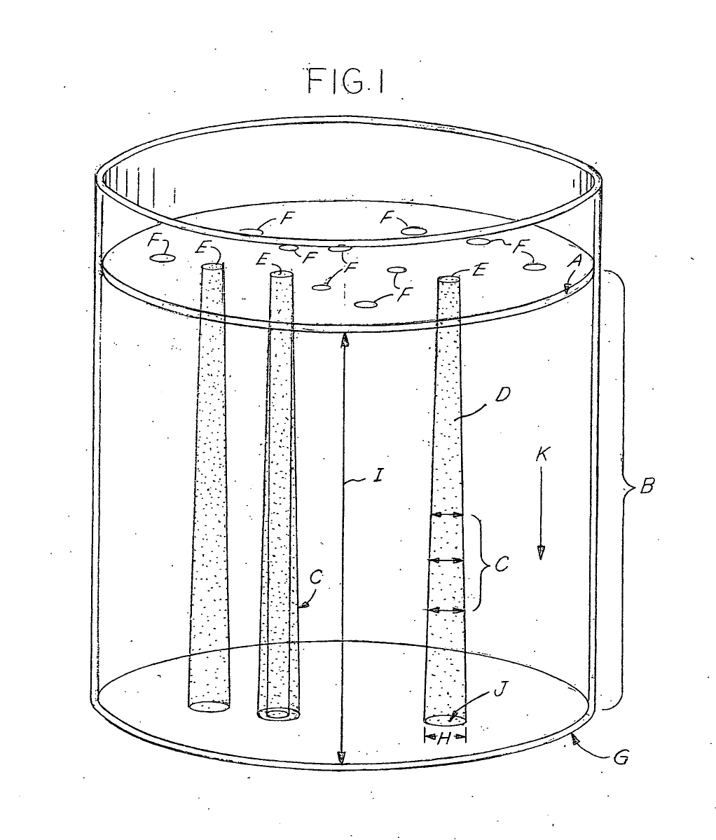

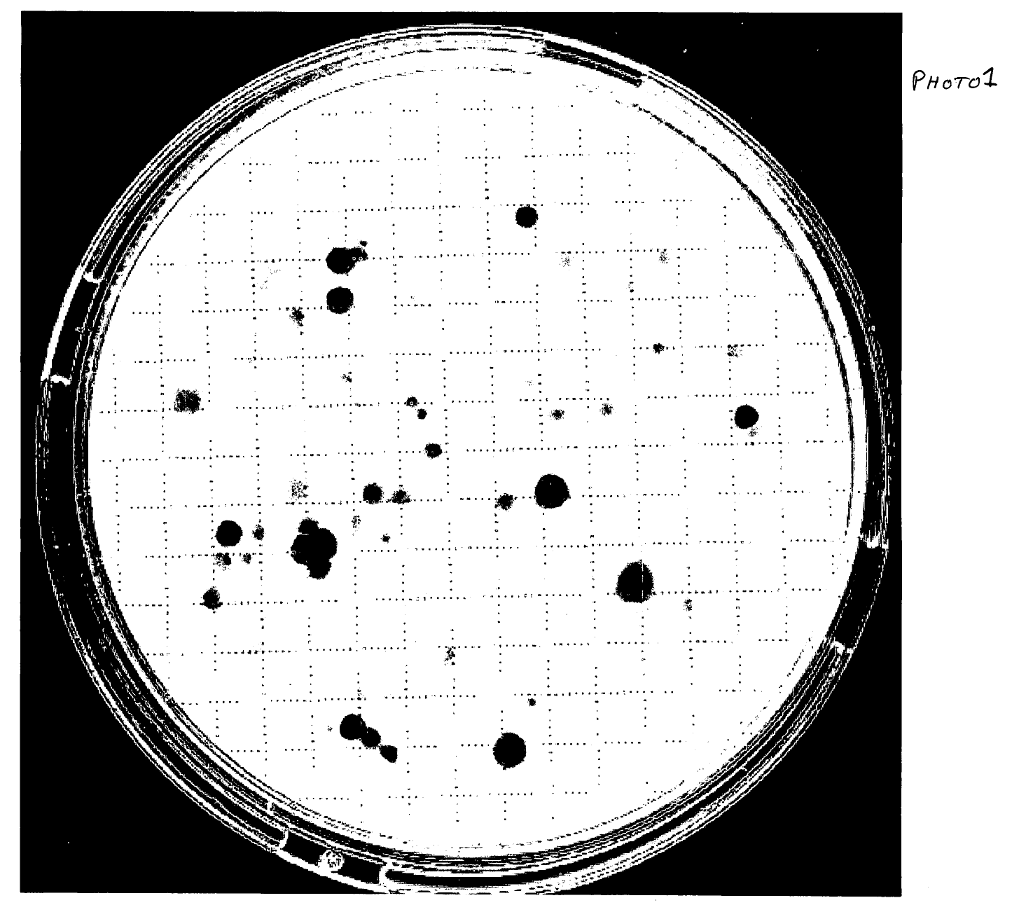

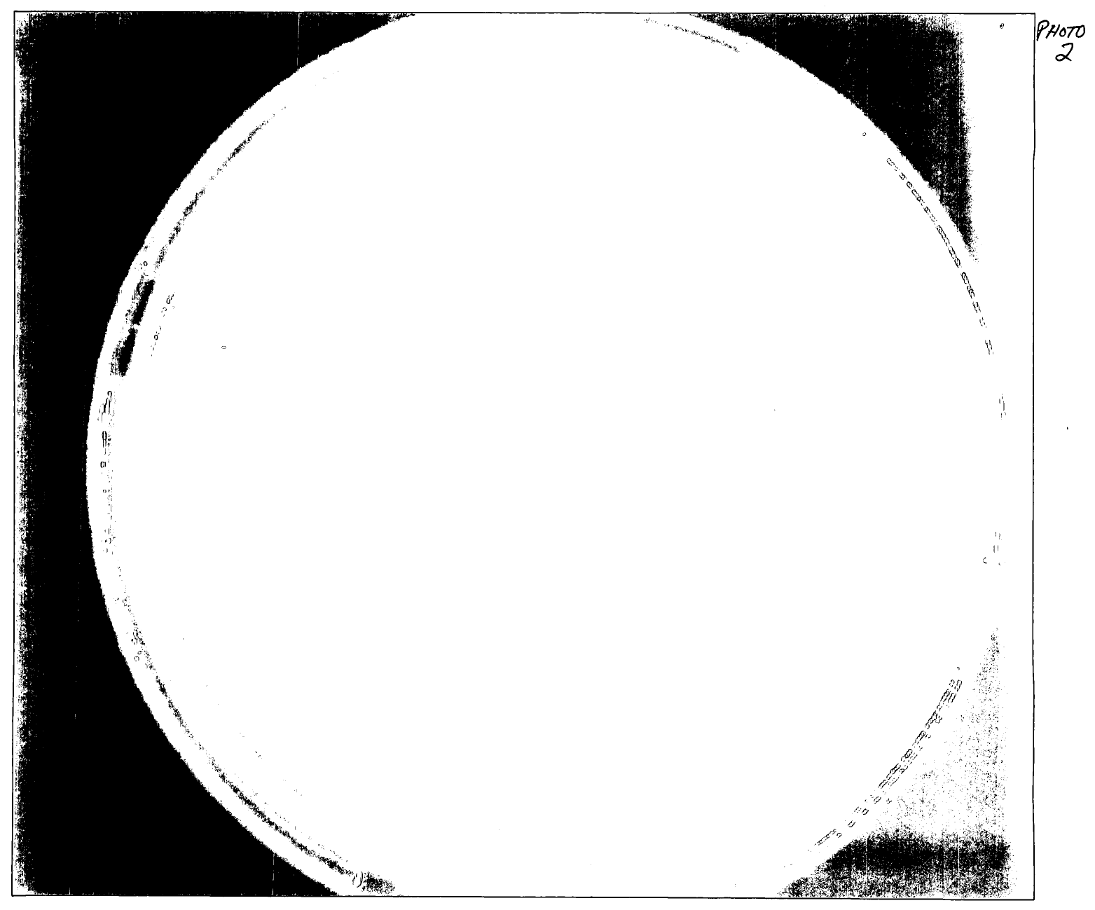

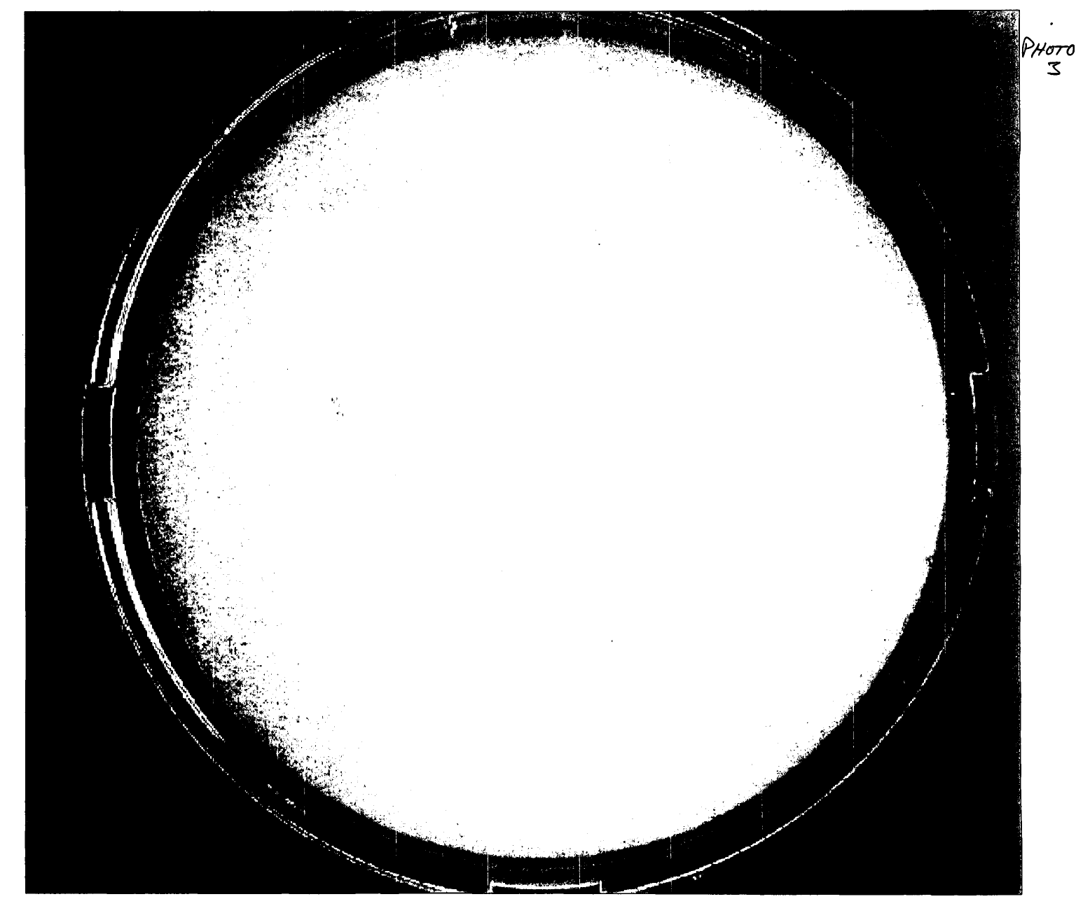

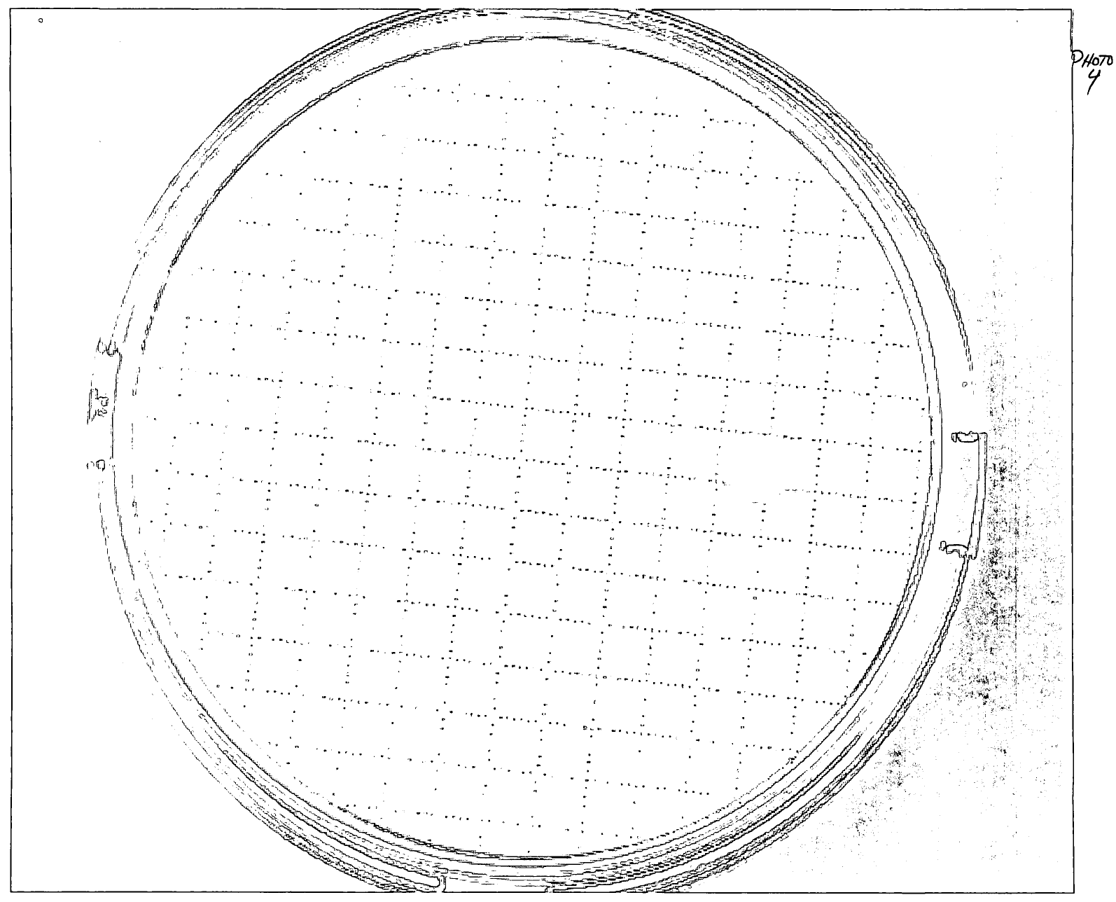

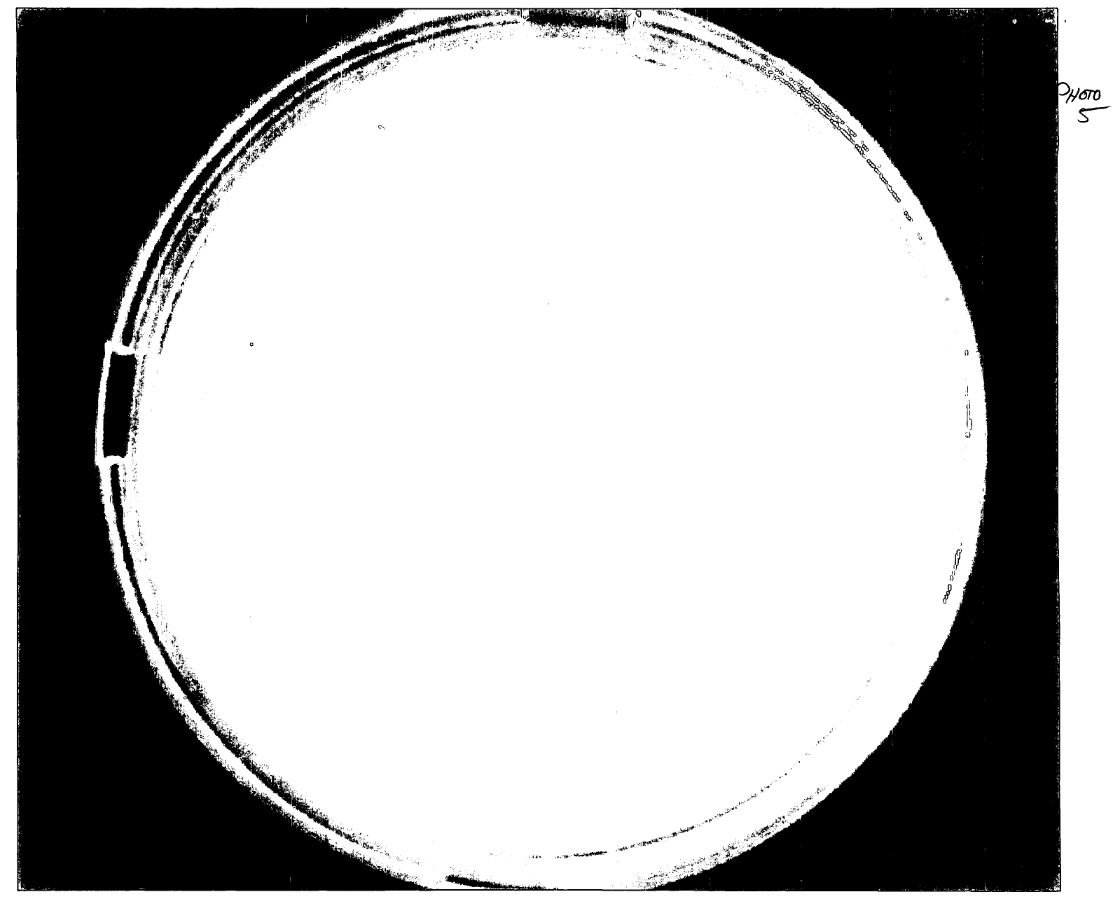

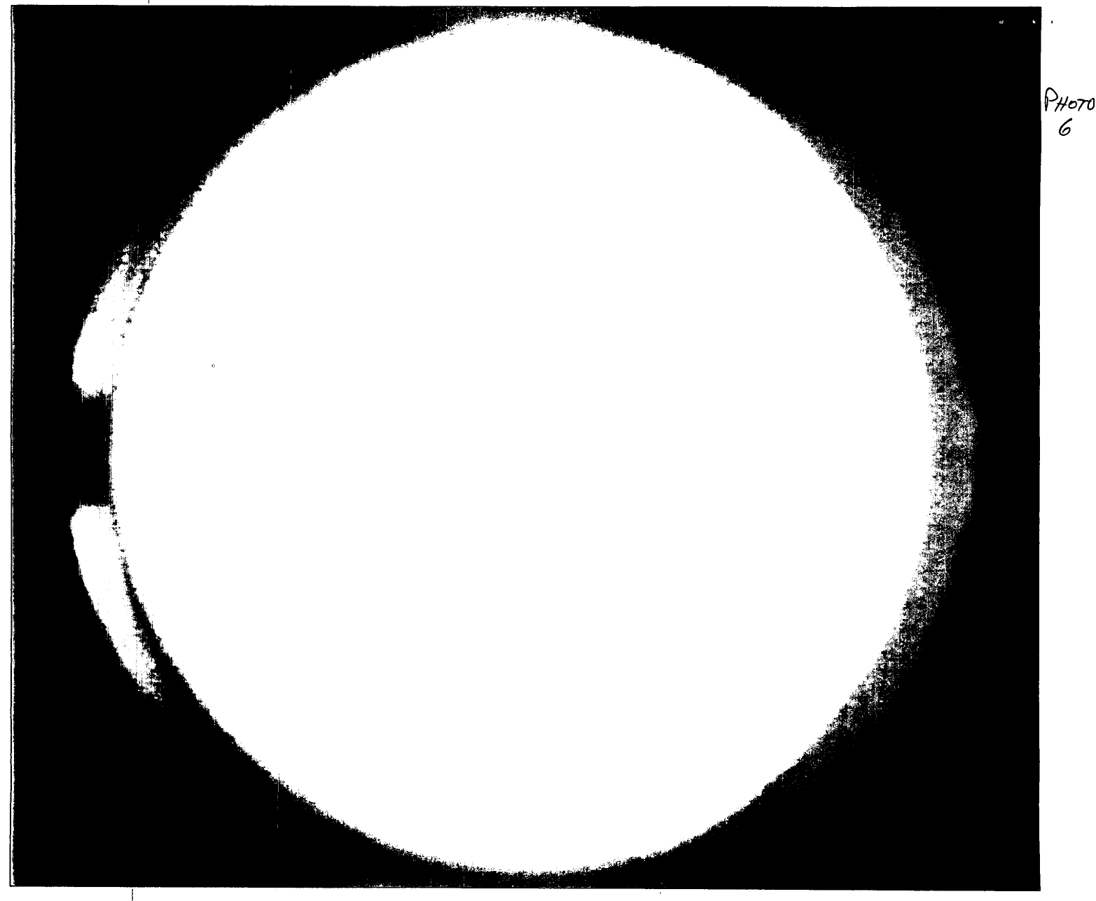

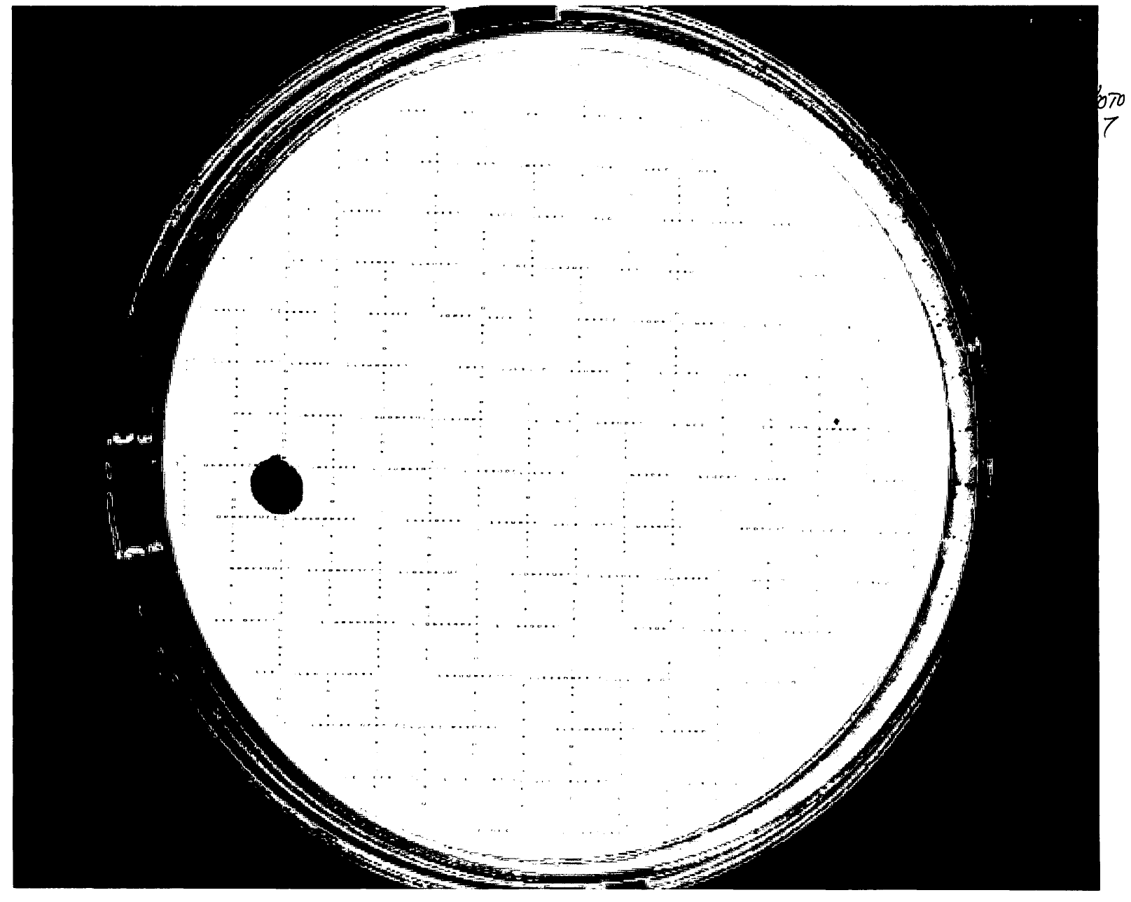

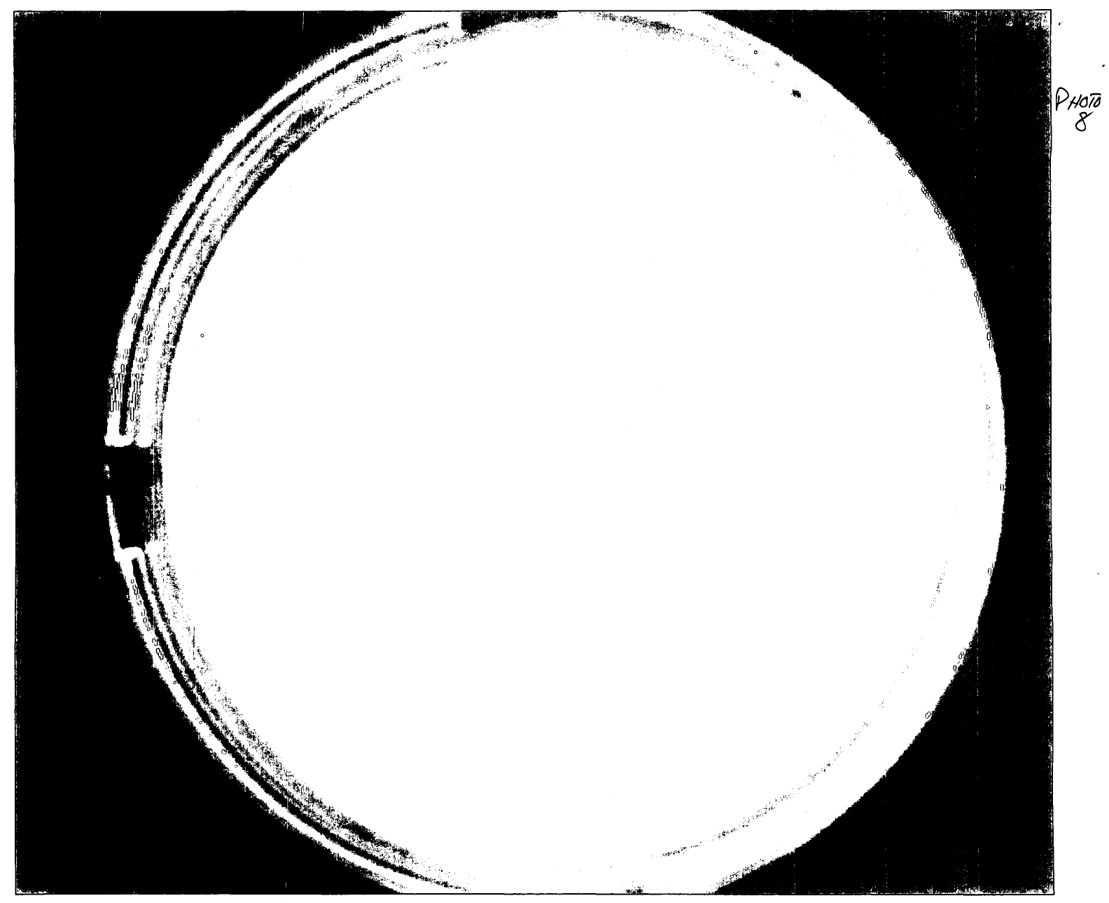

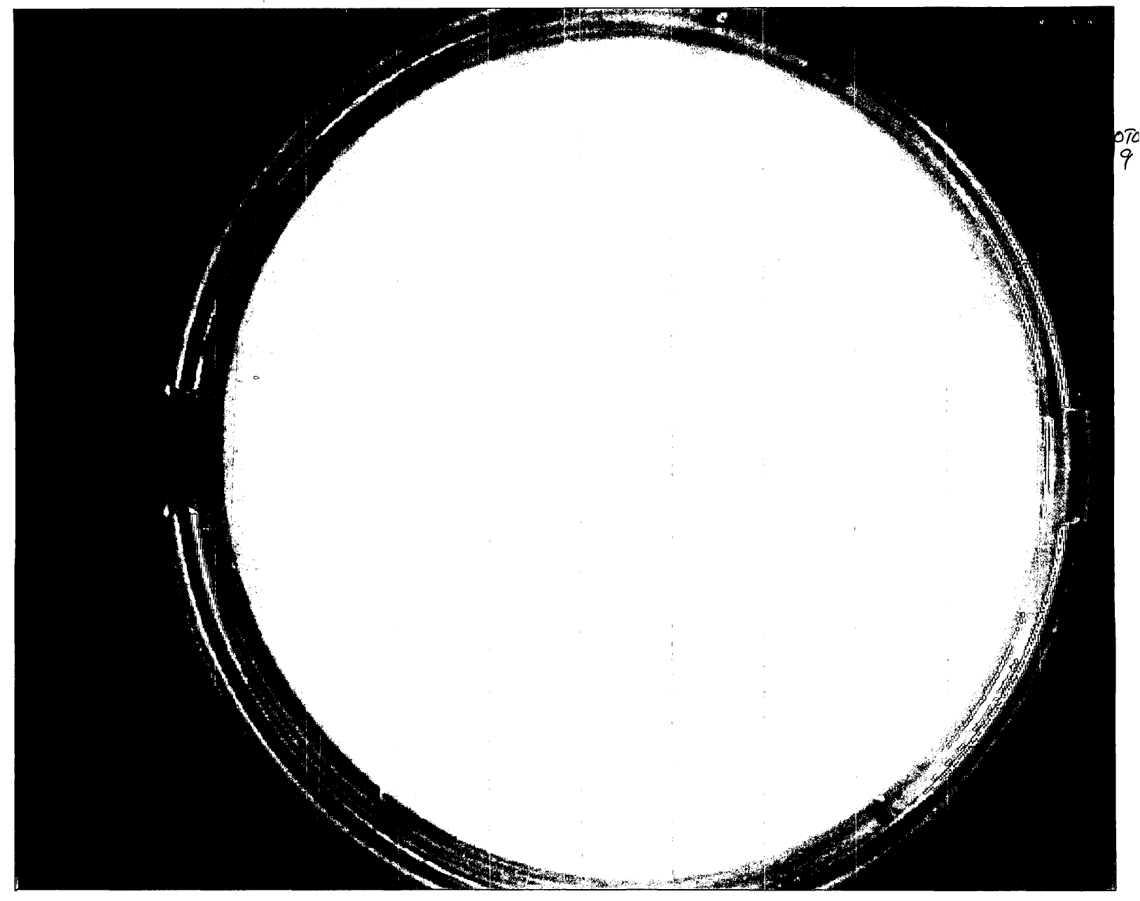

Photo 1 shows colonies growing on the upper surface of a pad;

Photo 2 shows the colonies in Photo 1 as detected in UV light;

Photo 3 shows the colonies in Photo 1 as detected from the bottom of a pad;

Photo 4 shows six different bacteria species on a filter;

Photo 5 shows the bacteria in Photo 4 as detected under a UV light;

Photo 6 shows the bacteria in Photo 4 as detected from the bottom of a pad;

Photo 7 shows the bacteria in Photo 4 detected due to use of a fluorogenic enzyme substrate;

Photo 8 shows the bacteria in Photo 7 as detected in UV light; and

Photo 9 shows the bacteria in Photo 7 as detected from the bottom of the filter.

### DETAILED DESCRIPTION OF PREFERRED EMBODIMENTS OF THE INVENTION

It has proven to often be beneficial in certain biological item testing (e.g.—bacteria, fungi/yeast, enzyme activity, gene I.D.) to use a fluorogenic substrate or chromogenic substrate producing a fast fluorogenic or chromogenic quality with a solid assay. This may be done if a petri dish or container has an absorbent pad, used as a base, in contact against the bottom of the dish or container under the gel or wetted with the test broth, or has a solid (e.g.—gelled) layer and no pad.

The thickness of the absorbent pad or gel can be important with regard to the speed of detection. A thinner pad can minimize the time of movement of any fluorogenic or chromogenic quality from the point of production, into the pad where it can be detected, often as a spot, from the pad underside, as quickly as possible. Regardless of the type of pad used, it can be important that the spot(s) can be detected from the underside of the pad.

Thinner pads may also be less expensive than regular-sized pads. In any case it is thought that the type, as distinguished from its thickness, of pad used (except for toxicity concerns) has not generally been an issue in the prior literature. Currently, a standard thick-type pad is commonly used for membrane filtration. Pads are not commonly used in agar and gel tests currently. It is suggested that a pad thickness between 400 and 1000 micrometers will provide a suitable test in a reasonably fast time period.

The detection of any fluorogenic or chromogenic qualities from the underside of the pad is often particularly important when more than one fluorogenic or chromogenic substrate producing a fast chromogenic or fluorogenic quality is used in the test medium. As an aspect of this invention other types of substrates are suited for use with this technique and/or techniques to be described later. For instance, it was found that different fluorogenic or chromogenic enzyme substrates can possess different useful properties. For example, it is thought that traditionally used fluorogenic and chromogenic enzyme substrates have been used to produce essentially a single useful color quality, (e.g. a fluorogenic quality or a chromogenic quality respectively). A single type of enzyme substrate producing more than one different color quality, e.g. a fluorogenic quality and a chromogenic quality, is herein termed as a dual enzyme substrate. Use of more than one quality due to use of at least a single enzyme substrate producing more than one different color quality used to detect an item, (e.g. the same enzyme reaction) can be extremely valuable to the art, and is considered unique and is an example of an aspect of the original disclosure of the method invention. The item may be any thing detectible by enzyme activity (e.g.—an aggregation of dead, non-viable, or living viable microorganisms). This method is herein disclosed and characterized as a Dual Enzyme Substrate Method. A Dual Enzyme Substrate Method is considered unique and is an example of an aspect of the original disclosure of the method invention. One example uses both a fluorogenic quality and a chromogenic quality, each of which is used to at least detect the presence or absence of enzyme reaction,

In another embodiment of the invention, some enzyme substrates are used which produce a slow fluorescent quality that is used to at least to detect the presence or absence of an item with a solid assay. Substrates of this type are referred to as a “New Fluorescent” or “NF” Substrates This is an example of an aspect of the original disclosure of the method invention and is considered to be the first recognition and practical application of this. A prototype substrate used was 6-chloro-3-indolyl-beta-D-galactoside. Other examples that can be used in this method are N-methyl-3-indolyl-B-D-galactoside and heat sterilized ELF 97 phosphate.

In a method of the invention, an enzyme substrate is used which produces a slow fluorescent quality (substrates of this type are referred to as “New Fluorescent” or “NF” Substrates) that is used to at least to at least detect the presence or absence of an item using a traditional microbiological membrane filtration method. This is an example of an aspect of the original disclosure of the method invention and is considered to be the first recognition and practical application of this substrate type used in a traditional microbiological membrane filtration method.

It is thought that indolyl derivatives may be used wherein the indolyl moiety nitrogen at the one position remains or is substituted by a heteroatom such as oxygen, sulfur, or others. The atom at this position may or may not have an alkyl, aryl, or other substituent. The carbon at the “three position” may be attached to an oxygen or a heteroatom such as nitrogen, sulfur, or others which may be part of or form a bridge to an enzyme recognized group. Such a substrate may be dual and/or produce a slow fluorescent quality.

For this invention, any of the substrates or uses for substrates are expected to work when used with various instrumentation (e.g. with cameras, colony counters or fluorometers), or the naked eye for item detection, (e.g.—microbial detection) and components of some substrates that are thought to allow for dual or slow diffusing quality detection, such as different indolyl moieties are expected to work as enzymatic or non enzymatic detectors,

The use of compounds that, due to non-enzymatic reaction, allow for production of a new slow diffusing fluorescent quality detecting the non-enzymatic reaction, is expected to work as an aspect of this invention. The use of compounds attached to a silyl group (e.g.—a 5-br-4-cl-3-indolyl-silylate) which, due to reaction with fluoride ions, may allow for production of a slow diffusing fluorescent quality is an example.

There are many types of assays for which aspects of this invention can be used. An assay monitoring enzyme activity indicative of disease or study of inhibitors on bacterial enzymes can be done. For example, to take advantage of speed and economics, if one is testing for Escherichia coli, an easy test would involve the use of any size petri dish or container containing a gelled medium or part of a matrix that contributes to a gel or supporting an absorbent pad covering the bottom or a gelled matrix. If a pad is used a normal thickness pad can work if test speed is not crucial, but if rapid results are desired, a thin pad should be used. A medium with a fluorogenic enzyme substrate, for example, either 4-methylumbelliferyl-beta-glucuronide or 4-methylumbelliferyl-beta-D-galactoside (MUG) or MUG with various nutrients, (e.g. casein or soytone) may be added to the pad. After a test sample is subjected to membrane filtration, the filter is placed onto a pad containing medium. The petri dish is incubated and monitored for detection of E. coli by fluorescent spot(s) with UV light through the bottom of the petri dish.

The following is information to accompany a series of photos used to demonstrate principles of the original disclosure of the invention.

Photo 1 shows, at 18 hours, detected E. coli (chromogenic blue colonies) and non-E. coli bacteria (chromogenic pink colonies) on the surface of a micropore membrane filter resting on an absorbent pad with the liquid Coliscan® MF Plus (containing tryptophan which may provide for the indole test) growth medium which contains a fluorogenic enzyme substrate 4-methylumbelliferyl-beta-D-glucuronide (MUG gluc).

Photo 2 shows the same plate and same view as shown in Photo 1, but as seen under direct long wave UV light. It is to be noted that the colonies match in position number on the plate. It should also be noted that virtually all the detected colonies are fluorescent from the surface of the membrane and that some E. coli colonies exhibit fluorogenic “fuzziness” around the edges due to the fast fluorescent quality due to the MUG gluc.

Photo 3 is the same plate as seen in Photos 2 and 3, but the plate is turned over and viewed from the bottom in UV so the fluorescent spots detecting the E. coli are apparent as nearly a mirror image of the pattern of the first two photos. Note the fluorescent quality used to detect the non-E. coli is less intense from this side.

Photo 4 shows eight hour growth of six different species of bacteria spotted on a micropore membrane filter resting on an absorbent pad with growth medium commercially available and sold under the name of Coliscan® MF (containing tryptophan which may provide for the indole test) and manufactured by Micrology Laboratories of Goshen, Ind., which does not contain MUG gluc. The organisms illustrated are: A) E. coli (6 o'clock); B) Citrobacter freundii (8 o'clock); C) Klebsiella pneumoniae (10 o'clock); D) Enterobacter aerogenes (12 o'clock); E) Salmonella typhimurium (2 o'clock); and F) Aeromonas hydrophila (4 o'clock).

Photo 5 is the same plate and same view as shown in Photo 4, but as monitored under direct long wave UV light. Note that A, B, C and D all exhibit bright blue fluorescence. This fluorescence is present despite the fact that no significant amount of MUG gluc was in the growth medium formula. The detected fluoresence herein demonstrates that the discovery and proof of utility of some single indolyl based enzyme substrates (e.g.—6-cl-3-indolyl-B-galactoside in the Coliscan® MF) that produce a slow fluorescent quality used to at least detect presence or absence a target item, (e.g.—microbe or enzyme activity), is accomplished by the present invention, and is an aspect of the original disclosure of the method invention.

Photo 6 is the same plate in Photos 4 and 5, but the plate is turned over and viewed from the bottom, and the indicator fluorescence detected in the cultures when monitored from the top is less intense.

Photo 7 shows eight hour growth of the same six species, in the same positions on the upper surface of a filter, of bacteria as shown in Photo 4, but in this case the absorbent pad is soaked with a medium commercially available and sold under the brand name ECA Check® MF Plus (containing tryptophan which may provide for the indole test) which contains the fluorogenic enzyme substrate MUG gluc and is manufactured by Micrology Laboratories of Goshen, Ind..

Photo 8 is the same plate and same view as shown in Photo 7, but as monitored under direct long wave UV light. Note that A, B, C, D and F all exhibit fluorescence in this top view. According to the prior art, it almost certainly would have been assumed that this fluorogenic quality is due to MUG gluc. Photo 9 shows that this assumption would be wrong, and that the fluorogenic quality is due to a slow fluorogenic quality due to 6-cl-3-indolyl-B-galactoside used to detect A, B, C, D, and F, as an aspect of the original disclosure of the invention and an improvement to the prior art.

Photo 9 is the same plate as 7 and 8, but the plate is turned over and monitored from the bottom and there is fluorescence detected, fast fluorescent quality due to MUG gluc. In this case, only A (E. coli) is showing this fluorescence from this side of the plate. None of the other bacterial species exhibit this fluorescence from this side of the plate. This demonstrates that according to the prior art B, C, D, and F would almost certainly have been considered positive for B-glucuronidase if viewed from the top. However, such a consideration would have been an error.

The above examples demonstrate how in an assay (e.g. medium), a wide variety of combination of enzyme(s) substrates, enzymes, or bacterial genera may be used or tested for. As an aspect of this invention; fluorogenics such as, but not limited to, derivatives of coumarin such as methylumbelliferone or trifloromethylumbellferone, or some indolyl, fluoroscein, or resorufin or rezasurin, fluorescent tetrazolium salts, carboxy fluoroscein, carboxy rhodamine, tetramethylrhodamine, carboxymethylumbelliferone, or other fluorogenic molecules (but not limited to these), chromogenics such as, but not limited to, indolylbasedenzyme substrates, nitrophenyl substrates, phenolpthalein substrates, salicin, esculin, tetrazolium salts or other chromogen molecules), and any combination of enzyme(s) such as, but not limited to, glycosidases, phosphatases, sulfatases, DNAases, RNAases, phosphoglycosidases, arylphosphatases, arylsulfatases, esterases, lipases, caprylases, ATPases, apyrases and any other enzymes that can be chromogenically or fluorogenically detected, indicating any combination of items may be used, such as any genus or genera of organism or cell, (e.g. bacteria, fungi or viruses).

Drawing 1 shows an upright model of the new method, not necessarily drawn to scale. It depicts an open container with organisms on a surface. A represents a membrane filter, if present. B represents an absorbent device, e.g., pad or gel or both, if present. A and B may constitute the base. C represents any lateral movement of fast diffusing fluorogenic or chromogenic quality as K, forces, might move them down in the petri dish. D represents fast diffusing fluorogenic or chromogenic quality. E represents E. coli, fluorescing under UV/black light because of fast diffusing fluorescent quality. It may be detected in part because of the fast or slow chromogenic quality. F represents organisms that do not allow the fast fluorogenic quality and/or fast chromogenic quality due to target enzyme(s). Both E and F may fluoresce or be other wise detectable on the surface at the top due to substrate(s) that allow for, due to enzyme reaction, slow chromophoric and/or slow fluorescent product quality. The bottom of the container is G. H is the width of the fluorescent spot detected through the bottom of the dish, and may be represented in the drawing as wider than actual for purposes of this model. I is the thickness of the absorbent pad or gel or both. J is a fluorescent spot as detected through the bottom of the dish, as soon as it is detectable at any point during movement through the pad or gel or both, as when it nears the bottom of the pad or gel or both. K is force moving the fluorophoric/chromophoric product quality downward. The lesser the value of I, the thinner the absorbent pad may be, and the less distance the fluorophoric/chromophoric qualities must move downward, and the sooner J may be detected and the less C may occur and the less H may be (smaller spot) and the sooner the test results may be detectable. D must be fast diffusing for this to occur.

As mentioned earlier, this invention also relates particularly to the detection of entities through the use of a newly defined group of enzyme substrates that we will reference as dual enzyme substrates. They are characterized by their capacity to allow expression, due to enzymatic activity of more than one distinguished quality, for instance, both a chromogenic quality detectable in visible light and a fluorescent quality detectable under long wave UV radiation. These qualities may coincide, be present simultaneously or at separate time intervals during the enzyme activity period. Until the present discovery of this novel property of and use for dual activity, it was generally assumed and accepted that diagnostic enzyme substrates tend to be used to just produce fluorescent or chromogenic quality. However it is thought that none has been previously described or generally used as producing more than one useful distinguishable appearance, such as having both fluorescent and chromogenic properties, both of which are proven useful in diagnostic applications by the present invention.

Dual enzyme substrates may be used to great advantage alone or in combination with other substrates, which have previously been generally used as only being fluorescent or chromogenic.

A prototypic dual enzyme substrate that was involved in the initiation of this invention is 6-chloro-3-indolyl-β-D-galactoside, as previously described above. Although 6-chloro-3-indolyl-β-D-galactoside will be used for illustrative purposed concerning applications and novel uses in this discussion, it is not meant to limit the scope of the invention of media containing compounds used for the novel properties they possess or uses for other compounds (e.g.—some N-methyl-indolyl based substrates) having a dual nature.

Prior to this invention, 6-chloro-3-indolyl-β-D-galactoside has been used as a chromogenic enzyme substrate in diagnostic media to identify entities based upon the production of a red/pink slow diffusing product appearance, due to reaction with the enzyme B-galactosidase. It is thought that no previous note has been taken of any fluorescent quality, much less one that is slow diffusing, such as is associated with the enzyme product of this substrate. Use of a slow diffusing fluorogenic appearance due to enzyme reaction with an indolyl based enzyme substrate for enzyme reaction detection is thought to be novel in the art.

Some of the following are examples of uses for dual enzyme substrates and/or enzyme substrates producing slow fluorescent quality, among other enzyme substrate types:

Materials were obtained from different sources: Coliscan Easygel, Coliscan Plus Easygel, Coliscan MF, Coliscan MF Plus, Pretreated Easygel dishes, 50 mm petri dishes, absorbentpads, 45 microm membrane filters, droppers, swabs, inoculation loop from Micrology Labs, 6-cl-3-indolyl-B-glucoside, 6-cl-3-indolyl-B-galactoside, 6-cl-3-indolyl-Phos, 5-br-4-cl-3-indolyl-Bglucuronide, 5-br-4-cl-3-indolyl-Bgalactoside, IPTG from Inalco, N-methyl-3-indolyl-Bgalactoside from Biosynth, 5 mM in water ELF 97 PHOSPHATASE SUB from Invitrogen, peptone, casein from Global Bioingredients, potassium phosphate from Amresco, beef extract from Marcor, yeast extract from BioSpringer, agar from AEP. NaCl, pyruvateand other ingredients can be obtained from Sigma. Aerobic Petrifilm™ from 3m, anaerobic bags and sachets from Remel.

Basal Medium

Following is a general formulation based upon common ingredients that can be used in methods of this invention. This specific formulation should not be interpreted to be the only usable combination. In fact, there may be many variations and additions and subtractions of ingredients, depending upon the specific targets toward which the medium is aimed. There may be, in some applications of the present invention, a resuscitation/repair/pre-incubation step which may be composed of some of these ingredients.

A medium was made comprising the following ratio of ingredients:

a. peptone—3-6 grams

b. yeast extract—1-3 grams

c. dipotassium phosphate—1-3 grams

d. sodium chloride—3-5 grams

e. inducer—50-200 mg. (e.g. IPTG) (optional)

f. resuscitation, repair or growth stimulating agent—0.5-2 gm (e.g. sodium pyruvate, peptone, sorbitol, etc.,) (optional)

g. buffer (optional for controlling pH)

h. selective inhibitors (optional—may include but not be limited to antibiotics, bile salts, surfactants or related compounds). If one or more inhibitors are included, the type and amounts will vary with the desired effect upon the target organisms.

i. Gelling or solidifying agent (optional—may include agar, pectin, alginate, or other gums) The types and amounts are determined by the desired effects.

j. Tryptophan—(which may provide for the indole test) (optional)

k. glucose (optional)

l. pH indicator such as neutral red or crystal violet (optional)

m. kaeolin as an opaquing agent (optional)

n. deionized or distilled water—1 Liter

Media ingredients (e.g. nutrients) and Sample Entities (e.g. Target organisms)

Media may serve as sources of ingredients that can promote detection of Sample Entities, such as Target organisms or items as in examples described in this document. It is now, from this disclosure, obvious to one knowledgeable and experienced in the art of this invention that there is not just a single medium containing exact ingredient quantities that must be used to successfully to achieve acceptable results. Insisting that there can be no variation in a set of ingredients with exactly designated amounts of each ingredient to achieve the purpose of the method or medium is now contrary to the experience and/or expertise in the art. Therefore, the media (ingredients and amounts) that are listed with the various following examples were used and found by the inventors to give useful and satisfactory results that demonstrated the validity and novelty of the invention, but it should not be assumed that variations in the media formulations are outside the scope of this invention or can be argued to constitute a new and unrelated invention.

The sample entities in the test samples may comprise but not be limited to various types and species of enzymes and microbes, including bacteria and fungi. In the following examples where the entities are bacteria, the bacterial species used may comprise combinations of Escherichia coli, Enterobacter aerogenes, and Pseudomonas sp. E. coli and Enterobacter aerogenes are members of the Coliform Group. By definition, Coliform bacteria produce the enzyme B-galactosidase and therefore any coliform bacterial species will generally respond the same as the Enterobacter aerogenes that was used in these described examples. In addition, most E. coli strains or varieties produce the enzyme B-glucuronidase (in addition to B-galactosidase) and so will generally demonstrate a unique enzyme profile among coliforms. (Where the entities are not bacteria, they may comprise other entities (e.g. enzymes, genes and fungi).

One of the embodiments of the invention is improved speed of item detection, using indicator substrates. Therefore it should be noted that the generation times for living target items vary and so ideally the method of the invention should comprise monitoring at different times from the beginning of incubation to achieve the fastest detection, and therefore when a time such as 8-14 hrs is suggested herein, this does not mean that results might not be detected sooner.

### Example 1

a medium was made comprising the following ratios of ingredients:

a. peptone—5 grams

b. yeast extract—3 grams

c. dipotassium phosphate—3 grams

d. sodium chloride—5 grams

e. 6-chloro-3-indolyl-beta-D-glucuronide—100 mg

f. IPTG inducer—150 mg

g. deionized water—1 Liter

The steps of use being:

a. the above Basal Medium was sterilized at about 15 min/15 lb pressure (121 C) as are many media in this disclosure, and (approximately 2 mL) is added to a pad covering the bottom of a small petri dish; (The specific amount is at least in part determined by the thickness and dimensions of the pad and how much medium it takes to wet pad.)

b. An aqueous sample containing entities to be quantified and identified (in this case Escherichia coli and Enterobacter aerogenes, both coliform bacterial species) was subjected to membrane filtration. The micropore filter was then transferred (top side up) to rest on the surface of the pad;

c. The inoculated dish was then incubated at 35° C.;

d. At 8-14 hrs incubation the dish was opened and the open side of the dish placed under a long wave UV in the dark and examined

e. Colony forming units of E. coli were detected by a blue fluorescence, and the colony forming units of Enterobacter aerogenes did not or only minimally fluoresce to the naked eye. When the dish was observed in ambient (non-UV) light, there was no apparent chromogenic quality detected due to the 6-chloro-3-indolyl-beta-D-glucuronide, of the colonies detectable. Again, the discovery and proof of utility of an indolyl based enzyme substrate, e.g., 6-chloro-3-indolyl-beta-D-glucuronide, that produces a slow fluorescent quality, which is used to at least detect target items, was provided by the original disclosure present invention. The dish was returned to the incubator until 22-26 hrs lapsed and the observation process repeated. At this time, under the UV there was diminished detectable fluorescence, but under ambient light, the E. coli colonies (which were detected as fluorescent spots earlier) were detectable as red/pink dots and the Enterobacter aerogenes colonies were generally only detectable as opaque dots. This represents two additional embodiments of the present invention. One is use of an enzyme substrate producing a color quality used to detect target items, which after a period of time, dissipates, which provides another detection of the target items. This can be useful for early detection and monitoring of enzyme reaction. Substrates other than the one chosen for this example may also be used (e.g.—some other indolyl based substrate). The other embodiment of the invention is use of an enzyme substrate producing two color qualities, used to detect target items, and one of which, after a period of time, dissipates, which is also used to detect target items. One of the appearances can occur after the dissipation of the other, which is an additional detection of the target items. This can be useful for monitoring enzyme reaction for early detection of the quality that dissipates and then detecting the new quality indicating the reaction occurred. Substrates other than the one chosen for this example may also be used (e.g.—some other indolyl based substrate). These embodiments are additional examples of aspects of the invention of the original disclosure. It should be noted that as used herein, the term “diminish” or “dissipating” refers to fading of the detectable result, but not necessarily fading to the point of total extinction.

Many other examples of the above embodiments of the dual enzyme substrate method or use of enzyme substrates producing slow fluorescent quality, or the embodiments described for dissipating qualities exist.

### Example 2

The steps of use being:

a basal medium was made comprising the following ratios of ingredients:

a. peptone—5 grams

b. yeast extract—3 grams

c. dipotassium phosphate—3 grams

d. sodium chloride—5 grams

e. 6-chloro-3-indolyl-beta-D-glucuronide (80 mg)+5-bromo-4-chloro-3-indolyl-beta-D-galactoside (80 mg);

f. IPTG inducer—150 mg

g. deionized water—1 Liter

a. The above Basal Medium (approximately 2 mL) was added to a thin pad covering the bottom of a small petri dish;

b. An aqueous sample containing entities to be quantified and identified (in this case Escherichia coli and Enterobacter aerogenes bacteria) is subjected to membrane filtration. The micropore filter is then transferred (top side up) to rest on the surface of the thin pad;

c. This inoculated dish is then incubated at 35° C.;

d. At 8-14 hrs incubation the dish was opened, and the open side of the dish placed under a long wave UV in the dark and examined. Colony forming units of E. coli were detected by a blue fluorescence, and the colony forming units of Enterobacter aerogenes did not appear to fluoresce to the naked eye. When the dish was observed in ambient (non-UV) light, there was no or minimal apparent chromogenic quality detected due to the 6-chloro-3-indolyl-beta-D-glucuronide, of the colonies detectable. Again, the discovery and proof of utility of an indolyl based enzyme substrate, (e.g., 6-chloro-3-indolyl-beta-D-glucuronide), that produces a slow fluorescent quality, which is used to at least detect target items, was provided by the original disclosure present invention. There was not much fluorescence quality due to the galactoside substrate on the Enterobacter aerogenes colonies, nor was there much detected chromogenic quality of the Enterobacter colonies.

e. The lid was replaced and the dish returned to the incubator until 22-26 hours had lapsed and the examination process was repeated. At this time, there was little or no observable Escherichia coli colony fluorescence, but under ambient light, the E. coli colonies were chromogenic (e.g., dark blue/purple dots) The other (Enterobacter aerogenes) coliform colonies were chromogenic and appeared as green (teal) dots and were not fluorescent.

### Example 3

a medium was made comprising the following ratios of ingredients:

a. peptone—5 grams

b. yeast extract—3 grams

c. dipotassium phosphate—3 grams

d. sodium chloride—5 grams

e. 5-bromo-4-chloro-3-indolyl-beta-D-glucuronide (80 mg)+6-chloro-3-indolyl-β-D-galactoside(180 mg)+MU Glucuronide (75 mg)

f. IPTG inducer—150 mg

g. deionized water—1 Liter

The steps of use being:

a. The above Basal Medium (approximately 2 mL) was added to a thin pad covering the bottom of a small petri dish;

b. An aqueous sample containing entities to be quantified and identified (in this case E. coli and Enterobacter aerogenes coliform bacteria) was subjected to membrane filtration. The micropore filter was then transferred (top side up) to rest on the surface of the thin pad;

c. This inoculated dish was incubated at 35° C.;

d. The dish was inverted, and it was placed under a UV light. Bright blue fluorescent quality spots were detected representing each colony forming unit of E. coli. These fluorescent quality spots were detected by a fast fluorescent quality of the MU Gluc which had moved through the medium-saturated pad;

e. Now the dish was turned right side up, the lid was removed and it was placed under the UV light. Fluorescent blue quality spots represented the total coliform population (including the E. coli). This fluorescence was a combination of the slow fluorescent quality of a 6-chloro-3-indolyl-β-D-galactoside (indicating coliforms, including the E. coli) andth a fast fluorescent quality of the MU Gluc (indicating the E. coli). The colonies were not easily detectable, and some of the E. coli colonies were detectable as very tiny, chromogenic pale blue quality dots, and most other coliforms were not yet significantly chrogenically detectable in ambient light;

f. The lid was replaced, and the dish was returned to incubate until a total of 22-26 hrs lapsed and the dish was reexamined. At this time, the fluorescent quality spots detected from the underside of the dish (representing E. coli colonies) were detected as larger.

g. Upon turning the dish right side up and examining under UV, the previously fluorescent non-E. coli coliform colonies were detected by less fluorescence, but the E. coli retained some fluorescence and it has spread significantly. In ambient light, the non-E. coli coliforms were detectable by chromogenic red/pink quality dots, while the E. coli colonies were detected by chromogenic dark blue/purple quality;

This is an example of using two substrates producing a fluorescent quality that is different for each, and using the qualities to detect an item(s), and is an aspect of the invention covered under the original disclosure. Another example of another substrate that can be used with this method is a quinazilone (e.g.—ELF97) based substrate. The three fluorescent qualities allowed by these substrates are different and distinguishable wave length ranges, and may be detected by instrumentation more sensitive than the naked eye.

Following is a further example with Enterococcus being an organism that is detected using a substrate producing a slow fluorescent quality. Species of Enterococcus, Bacteroides, Clostridium, Escherichia coli and most microorganisms may be detected using various aspects of this invention.

### Example 4

a basal nutrient medium was made comprising the following ratios of ingredients:

a. peptone—5 grams

b. yeast extract—3 grams

c. dipotassium phosphate—1 gram

d. sodium chloride—3 grams

e. 6-chloro-3-indolyl-beta-D-glucoside (80 mg)

g. deionized water—1 Liter

The steps of use being:

a. The above Basal Medium (approximately 2 mL) was added to a pad covering the bottom of a small petri dish;

b. An aqueous sample containing entities to be quantified and identified (in this case Enterococcus bacteria) was spotted on a micropore filter

c. This inoculated dish was then incubated at 35° C.;

d. At 8-14 hrs incubation the dish was opened, and the open side of the dish placed under a long wave UV in the dark and examined;

e. Colony forming units of Enterococcus were detected by a blue fluorescence. When the dish was examined in ambient (non-UV) light, there was no or minimal apparent chromogenic quality, due to enzyme reaction with the 6-chloro-3-indolyl-beta-D-glucoside, detectable. Again, the discovery and proof of utility of a single enzyme substrate (e.g.—6-chloro-3-indolyl-beta-D-glucoside) that can produce a slow fluorescent quality which was used to at least detect target items was provided by the original disclosure of the invention.

f. The lid was replaced and the dish returned to the incubator until 22 hours lapsed and the examination process repeated. At this time, there was little or no observable fluorescence in UV, but under ambient light, the Enterococcus colonies were detected as chromogenic pink/red dots.

### Example 5

a medium was made comprising the following ratios of ingredients:

a. peptone—0.018 grams

b. yeast extract—0.012 grams

c. beef extract—0.012 grams

d. sodium chloride—0.013 grams

e. #1 6-chloro-3-indolyl-B-D-glucuronide—1.2 mg or #2 N-methyl-3-indolyl-B-D-galactoside—1.2 mg) or #3 a reported “5 mM in water” product purchased under the name “ELF 97 PHOSPHATASE SUB”—0.5 ml

g. deionized water—5.5 ml

The steps of use being:

a. The above Basal Medium was made with 6-chloro-3-indolyl-B-D-glucuronide and then with N-methyl-3-indolyl-B-D-galactoside and then with “ELF 97 Phosphatase Sub”. All three, #1-3, numbered according to the substrate they contained, were sterilized at 15 min/15 lb pressure (121° C.) as were many media in this disclosure, and (approximately 0.5 mL) of each of the three was added to a separate quadrant cut from an absorbent pad covering the bottom of a small petri dish; A quadrant cut from a membrane filter was put on each pad quadrant and inoculated with E. coli and incubated at 35° C.

d. At about 5½ hours with medium #1, the E. coli inoculated area of the filter was detected by slow diffusing blue fluorescence, possibly with some of the fluorescence detectable on the portion of the filter with no E. coli.

e. At about 5½ hours with medium #2, the E. coli inoculated area of the filter was detected by slow diffusing green fluorescence, possibly with some of the fluorescence dectectable on the portion of the filter with no E. coli.

f. At about 5½ hours with medium #3, the E. coli inoculated area of the filter was detected by slow diffusing yellow/green fluorescence, possibly with some of the fluorescence detectable on the portion of the filter with no E. coli.

An aspect of the invention is the use of some indolyl based substrates each to produce detectable qualities indicating facultatively anaerobic/anaerobic/microaerophilic organisms. They may be a fluorescent quality and different chromogenic qualities.

### Example 6

An example is the use of a substrate producing a slow fluorescent quality that can detect facultatively anaerobic/anaerobic/microaerophilic organisms.

A medium comprising the following ingredient ratios was formulated and sterilized:

| | | |
|---|---|---|
| Proteose peptone #3 | 5 | gm |
| Yeast extract | 2 | gm |
| Soy extract | 2 | gm |
| Beef extract | 2 | gm |
| Sodium chloride | 3 | gm |
| Deionized water | 1000 | mL |

To separate aliquots of the above nutrient medium, certain indolyl based substrates were added as follows at a concentration of about 300-500 mg/liter of medium. These were used to make media #1-4, according to the substrate below.

1. 6-chloro-3-indolyl phosphate

2. 6-chloro-3-indolyl-B-D-glucuronide

3. 6-chloro-3-indolyl-B-D-galactoside

4. 6-chloro-3-indolyl-B-D-glucoside

0.5 ml medium #3 was added to two, 0.5 ml medium #2 was added to three, 0.5 ml medium #1 was added to two and 0.5 ml medium #4 was added to two absorbent 47 mm pads in a 55 mm petri dish
A 0.45 pore size membrane filter was placed on the surface of the pad.
The surface of the filter in each petri dish was inoculated
Dishes of medium #1-4 were inoculated with B. fragilis ATCC 25285. Dishes of medium #1-4 were inoculated with C. perfringens ATCC 13124. A dish of medium #2 was inoculated with E. coli ATCC 25922. The inoculated dishes were put in anaerobic bags The B. fragilis and the C. perfringens inocula were from colonies grown in anaerobic conditions, and the E. coli was from an aerobic broth culture.

### Incubation was at 35° C.

Detection was done under visible light and UV and photographs were taken at 15 minutes, at 2½ hrs incubation, at 4½ hrs incubation, and at 19 hrs incubation

By 19 hrs B. fragilis was detected by slow fluorescent quality by chromogenic dull bluish-grey quality with virtually no hint of pink or red with media #1, 2, 3 & 4, with the strongest fluorescence with #3 (galactoside) and the weakest with #4 (glucoside). C. perfringens was detected with media #1 and 4 by slow fluorescent quality and chromogenic dull grey quality, with the strongest fluorescence in #1. E. coli was detected with medium #2 by slow fluorescent quality.

Another aspect of this invention is in the use of medium containing substrates and heat treated, or medium heat treated with aseptically added indicator substrate producing a (same or contrasting if more than one substrate is used together) slow fluorescent quality used for detection of aerobic, facultatively anaerobic, anaerobic, or microaerophilic organisms.

### Example 7

A medium comprising the following ingredient ratios was made and sterilized:

| | | |
|---|---|---|
| Proteose peptone #3 | 0.03 | gm |
| Yeast extract | 0.012 | |
| Soy extract | 0.012 | |
| Beef extract | 0.012 | |
| Sodium chloride | 0.018 | |
| Deionized water | 6 | ml |

To separate aliquots of the above nutrient medium each of one of the following indicator substrates was added. Each specific indolyl based substrates were added as follows at a concentration of about 300-500 mg/liter of medium, and the ELF substrate (a reported “5 mM in water” product sold under the name “ELF 97 PHOSPHATASE SUB”—approximately—0.5 ml) which was present at 0.5 ml. These were used to make media #1-4, according to the substrate below. There were different broth based media formulated, heat sterilized vs aseptically added substrate for the ELF.
#1. an ELF phosphatase substrate (a reported “5 mM in water” product purchased under the name “ELF 97 PHOSPHATASE SUB”)

#2. 6-chloro-3-indolyl phosphate

#3. 6-chloro-3-indolyl-B-D-galactoside

#4. 6-chloro-3-indolyl-B-D-glucoside

0.5 ml medium #3 was added to three separate quadrants 0.5 ml medium #1 was added to two separate quadrants and 0.5 ml medium #4 was added to one separate quadrant, each cut from a absorbent 47 mm pad in a 55 mm petri dish
A quadrant cut from a 0.45 pore size membrane filter was placed on the surface of the wet pad. The filter in each petri dish was inoculated with a 1.5 mm loop of culture for each of three different bacterial species.
Two dishes (one medium #2, one medium #4) were each inoculated with B. fragilis ATCC 25285. Two dishes (one medium #1, one medium #2) were each inoculated with C. perfringens ATCC 13124. B. fragilis and C. perfringens were incubated anaerobically in bags. Four dishes (two medium #1, two medium #2) were each inoculated with E. coli ATCC 25922. One set of E. coli was incubated aerocically and one anaerobically in bags. The B. fragilis and the C. perfringens inocula were from colonies grown in anaerobic conditions, and the E. coli was from an aerobic broth culture.
At 2 hrs E. coli was detected by fluoresence due to use of substrates #1-3, Clostridium was detected by fluorescence due to substrates #1-2, and Bacteroides was detected by fluorescence due to substrates #1-4.

Haugland teaches that the ELF substrate produces an “insoluble” product in an aqueous environment. Evidence was found that this is not true, but it diffuses in a slow manner.

Some currently known dual enzyme substrates are chromogenic Indolyl based enzyme substrates that can produce two or more fluorescent and/or chromogenic qualities in part due to the side chain on the indolyl at the #6 position. Their functional characteristics are not limited to this specific group of compounds. In the original disclosure of the dual enzyme method, 6-Cl-3-indolyl-B-D-galactoside was used as an example. Another example is N-methyl-3-indolyl-B-D-galactoside.

Another example of this invention is the use of a dual or non dual enzyme substrate producing a slow fluoresent quality, with, on and in, a solid assay, (e.g.—gel medium without a necessary pad or necessary membrane. In this example the substrate is 6-chloro-3-indolyl-B-galactoside in the medium Coliscan® Easygel® from Micrology Laboratories, L.L.C. in Goshen, Ind., USA., and N-methylindoxyl-B-D-galactopyranoside in an agar medium. (Photos a and b Set VI).

### Example 8

a. A solution consisting of the following proportions of ingredients was made. (15 gm agar 5 gm Peptone, 3 gm yeast extract and 3 gm dipotassium phosphate and 200 mg N-methylindoxyl-B-D-galactopyranoside/liter of deionized water). A test of Coliscan® Easygel® was obtained.
b. The agar media were sterilized and petri dishes were poured of both. As they started gelling, each was inoculated below the surface with target organisms (Escherichia coli), and following most gelling, each was inoculated on the surface with Escherichia coli. The inoculated dishes were then incubated at 35° C.
c. The dishes were monitored for detection of Escherichia coli both in UV light and in ambient light.
d. Both the E. coli that grew in the matrix and on the surface of the matrix were detected. both fluorescent and chromogenic qualities. (Set VII Photos a, b)

### Example 9

a. A dish of Coliscan® Easygel® (contains enzyme substrates 5-bromo-4-chloro-3-indolyl-B-D-glucuronide and 6-chloro-3-indolyl-B-D-galactoside) was poured. Prior to most gelling, the medium was inoculated below the surface with target organisms (E. coli) and, following gelling, both on the gel surface and on the surface of a membrane that was deposited on the gel at. Itwasincubatedat 35° C.
b. The inoculated dish was monitored for detection of E. coli both in UV light and in ambient light.
   b.

b. It has been confirmed that both fluorescent and chromogenic product appearances developed in both colonies of the E. coli that grew in the matrix and on the surface of the matrix and on the surface of the membrane. (Set VII Photos e, f).

An aspect of this invention is in the use of a substrate (which may be impregnated in or provided by a strip or piece of support, e.g., swab, or paper, for spot testing/confirming purposes, etc.) that produces a slow fluorescent quality, and may produce a fluorescent quality and chromogenic quality, both used if detected to detect a target item (e.g.—E. coli) wherein the substrate is a main carbon source (Example 10), or where it is essentially the only medium ingredient besides water (Example 11),

### Example 10

a. A device (in this case a sterile swab) was moistened with a medium (Coliscan Plus Easygel) containing the enzyme substrates 5-Bromo-4-chloro-3-indolyl-B-D-glucuronide, 6-chloro-3-indolyl-B-D-galactoside, and 4-MU-B-D-glucuronide.
b. The device, “a” (above) was used to swab a surface that was contaminated with a target organism (E. coli).
c. The device of “b” (above) was placed in a container at 35° C.
d. At 2 hrs E. coli was detected with the device by blue fluorescent quality.
e. At 4 hrs E. coli was detected with the device by blue/purple chromogenic quality.

### Example 11

a. A specific enzyme substrate (6-chloro-3-indolyl-B-D-galactoside), which was dissolved in deionized water, was introduced to devices (in this case sterile swabs) so that the device was moistened, but not to the state of saturation. The amount of enzyme substrate in the solution applied to the swab was about 2-3 mg.
b. The devices were then contacted with various samples containing the target organisms (Escherichia coli) A first device was touched directly to a colony of grown on a solid nutrient medium, the second device inoculated with a loop-full of a nutrient broth culture of E. coli, additional devices inoculated with deionized water containing E. coli bacteria, and a device was moistened with sterile deionized water only as a control were placed in a container and incubated at 35° C.
c. At 1 hour E. coli was detected with, the first device by pink chromogenic quality in visible light at the tip, and blue fluorescent quality below the tip. All the devices except the control exhibited blue fluorescence quality.
d. At 2 hrs E. coli was detected by pink chromogenic quality in with the first and second devices.
d. No significant ingredients other than enzyme substrate and water were needed.
   d. An additional embodiment of the invention is the combined use of at least two (A same or different) indicator enzyme substrates, each producing a slow (contrasting or not) fluorescent quality used to detect and/or differentiate one, two or more items (e.g.—enzyme reactions and microbes) with one solid assay. Some of these substrates may produce a slow chromogenic quality also used to detect the items. This is thought to be the first proof of practice of this method. Suitable substrates include, but are not limited to 6-chloro-3-indolyl-B-D-glucuronide, N-methylindolyl-B.D-galactopyranoside, ELF97 phosphatase, and 6-fluoro-3-indolyl, 4-chloro-3-indolyl, 5-chloro-3-indolyl, and 3-indolyl-B-D-galactoside substrates. A variety of one or more enzymes may be detected and quantified

### d. Example 12

An example of such a method uses two substrates 6-chloro-3-indolyl-B-D-glucuronide and N-Methylindoxyl-B-D-galactopyranoside. (Set III photos)

The steps of use being:
A medium comprising the following ingredient ratios was made:
a. peptone—5 grams
b. yeast extract—3 grams
c. dipotassium phosphate—3 grams
d. sodium chloride—5 grams
e. 6-chloro-3-indolyl-beta-D-glucuronide (80 mg) and N-Methylindoxyl-beta-D-galactopyranoside (75 mg)
f. IPTG inducer—150 mg
g. deionized water—1 Liter
a. 2 mL of the medium was added to an absorbent pad in a suitable container.
b. An aqueous sample containing entities (in this case #1 glucuronidase positive/galactosidase positive bacteria (Escherichia coli), #2 glucuronidase positive/galactosidase negative bacteria (Salmonella sp.), and #3 glucuronidase negative/galactosidase positive bacteria (Enterobacter aerogenes) was subjected to membrane filtration. The membrane was (top side up) on to the absorbent pad and the
c. The container was incubated at 35° C.
   d. The assay was monitored for detection of organisms by using instrumentation, (e.g.—photographing, and/or the eye).
d. At 6-9 hrs some #1 were detected by chromogenic blue quality (see Set II photo a) Few if any organisms were detected by fluorescent quality due to indicator substrates used.
e. At 10-14 hr most #1&2 were detected by fluorescent blue quality and most #3 were detected by fluorescent green quality. Some #1 were detected by chromogenic dark purple quality.
f. At 16-18 hr most #1 were detected by fluorescent blue quality and by chromogenic dark (almost black) purple quality, most #2 were detected by blue fluorescent quality and by chromogenic pink quality, and most #3 were detected by fluorescent green quality (see Set III, photo b) and by chromogenic green quality. (see Set III, photo a). At this time most colonies were detectable. A very dark, smaller compact appearance of many #1 was unexpected because it is thought to be a result of the combined Pink of the 6-chloro substrate and the light Green of the N-methyl substrate. It is thought that through the present invention this is the first discovery and proof of usefulness of combining a hydrogen N-substituted 3-indolyl based substrate and a non hydrogen N-substituted (N-methyl)-3-indolyl based substrate producing a more compact and unexpected chromogenic slow quality CFU. These stages can be detected by instrumentation (e.g.—photographed). (see Set III photos with interpretations).

Another example used Elf97 phos and 6-cl-B-glucuronide to detect and differentiate E. coli and Enterobacter with a solid assay.

It is known that there are microbes that can be detected by exhibiting natural chromogenic quality; (e.g.—Staphylococcus aureus detected by a yellow quality) or naturally occurring fluorescence in Ultraviolet light (e.g.—Pseudomonas aeruginosa, Pseudomonas fluorescens and Pseudomonas putida) all of which are commonly found in water and soil and which are associated with various diseases. Prior art has found that “the fluoresence signal is usually too small for visual detection” (Manafi, 1996). It is known that other types of microbes may also possess a fluorescent property.

An aspect of the invention is use of natural fluoresent quality due to a biological item and a fluorogenic enzyme substrate(s) producing a fluorescent (fast or slow) quality that dissipates to detect and differentiate some organisms, (e.g.—E. coli and some Pseudomonas). These Pseudomonas generally grow slower than coliforms, but they generally grow as CFUs that may be detected by a fluorescent and chromogenic quality that usually doesn't diminish by the time that the fluorescence of the coliforms has greatly diminished.

### Example 13

This example uses an indicator substrate producing a slow fluorescent quality and a natural fluorescent/chromogenic quality(s) to detect and differentiate a type of Pseudomonas from a Coliform bacterial type

A medium with the following ingredient ratios was made:
a. peptone—5 grams
b. yeast extract—3 grams
c. dipotassium phosphate—3 grams
d. sodium chloride—5 grams
e. 6-chloro-3-indolyl-beta-D-glucuronide (80 mg)
f. IPTG inducer—150 mg
g. deionized water—1 Liter
The steps of use being:
   a. 2 mL of the above medium was added to an absorbent pad that was in a small petri dish.
   b. An aqueous sample containing entities to be qualified and/or quantified, and identified (in this case, Escherichia coli coliform bacteria and Pseudomonas aeruginosa bacteria known as “target organisms”) was subjected to membrane filtration. The micropore membrane was then put (top side up) on the absorbent pad, and the petri dish was closed and incubated at 35° C.
   c. The assay was monitored for detection.
   d. At 6-8 hrs until about 18-20 hrs the E. coli were detected as fluorogenic blue quality by using instrumentation, (e.g., photographing), and/or the naked eye
   e. At 22 hr E. coli were detected by chromogenic pink quality and Pseudomonas by fluorescence by using instrumentation, (e.g., —photographing), and/or the naked eye.

(see Set IV photos and interpretations) (see Set IV photos and interpretations).

It is thought that some tetrazolium salts (e.g. 5-cyano-2,3-ditolyl tetrazolium chloride or triphenyltetrazolium chloride) may be used alone or in combination with some enzyme substrates as an aspect of the invention to provide faster detection and differentiation of items.

An important aspect of this invention is new uses for various indicator enzyme substrates. Two of these indicator enzyme substrate types (indolyl based and coumarin based) have been shown to withstand high temperatures (121° C.) without significant loss of effectiveness. This may not be true of all other indicator enzyme substrate types. This can be an important factor in the use of indicator enzyme substrate(s) media formulation and production for certain applications of the present invention.

It has been found that some indicator enzyme substrates can allow for more than one useful and differentiated quality in assays. These substrates were termed “dual” enzyme substrates, and now the additional related terms “duogens, digens, multiple enzyme substrates, multigens, polygens,” and so on are used herein to describe them. In the first disclosure of the invention 6-chloro-3-indolyl-beta-D-galactoside was used as a dual substrate. Two more examples are Resorufin-B-galactoside and di-B-galactosyl fluoroscein, and it is thought that the invention provides the first report of use of the dual nature of these substrates in an assay.

Aspects of this invention are both use of a dual substrate and use of an indolyl based substrate producing fluorescent quality in a broth medium. They may be applied as a presence/absence or mpn test.

### Example 14

Two Media formulations ratios were used to compare these aspects to use of a traditional MUgal.

e. a. peptone—5 grams
e. b. yeast extract—3 grams
e. c. dipotassium phosphate—3 grams
e. d. sodium chloride—5 grams
e. e. 6-chloro-3-indolyl-beta-D-galactoside (160 mg) or MU galactoside (100 mg)
e. f. IPTG inducer—150 mg
g. deionized—1 Liter

100 ml of the above medium using 6-chloro-3-indolyl-beta-D-galactoside was made and 10 mL put in a test tube.

The medium was inoculated with target organisms and incubated and monitored for detection.

At 8-12 hr fluorescence was detected

At 14 hr after shaking the test tube a chromogenic pink quality was detected.

100 mL of the above medium using MU galactoside was made and 10 mL put in a test tube.

The medium was inoculated with target organisms and incubated and monitored for detection.

At 8-12 hr fluorescence was detected.

(See Set I, Photos A and B of broth cultures of E. coli)

In addition, it was found with the present invention with a broth medium containing N-methyl-3-indolyl-B-D-galactoside and B-gal positive bacteria allowed enzyme reaction and a detectable green chromogenic quality that dissipated and then reappeared upon agitation. An aspect of this invention is use of some substrates, (e.g.—some Indolyl Based substrates) and/or non sterile ingredients and use appropriate inhibitors. (e.g.—antiobiotics) to repress non target items. Another application may use small test samples to detect the presence/absence of ambient or other waters or other liquid test sample (e.g.—foods and beverages) using a desired sample size and medium. [Different substrates including 6-cl-3-indolyl-acetyl-B-D-glucosaminide for fungi or 6-cl-3-indolyl-B-D-glucoside for enterococcus and appropriate inhibitors such as antibiotics may be used but are not meant to limit the variations.]

Alternatively, this aspect may make use of a method well known in the art where in the test sample/medium mix may be dispensed into wells or containers to “quantify” the numbers of coliform bacteria or other items that may allow detection and estimates enumeration as the “MPN” (most probable number).

### Example 15

This example shows how to detect Escherichia coli and General Coliform Bacteria, in Water or Other Liquid Test Samples

The following media Formulation ratios of ingredients were used, but the specific components and amounts of components may be varied depending on the items being detected.

| | |
|---|---|
| 1. proteose peptone #3 | 2 grams |
| 2. yeast extract | 500 mg |
| 3. tryptophane | 1 gram |
| 4. dipotassium phosphate | 2 gram |
| 5. bile salts #3 | 900 mg |
| 6. 6-chloro-3-indoxyl-β-D-glucuronide | 100 mg |
| 7. 5-bromo-4-chloro-3-indoxyl-β-D-galactoside | 100 mg |
| 8. IPTG (inducer) | 100 mg |
| | 6.7 grams (to test |
| | 1 L of test sample) |

Procedure: (similar to EPA use of 100 mL water samples for testing potable water)
1. 670 mg of the Media Formulation was put into ideally a clean, clear container with ideally leak-proof closure. “Clean” is meant to indicate that no liquid is present in the container and that no coliforms are present in the container. Ideally, the container is sterile consisting of glass or clear plastic material. The container can be a plastic bag such as some types of “zip-lock” or “whirl pac” bags so long as the composition does not allow significant interference with appearance detection.
2. Add 100 mL test sample of water that contained viable Escherichia coli and other coliform bacteria was added to the container.
3. The container was closed. (25 shakes recommended)
4. The container was monitored for Escherichia coli and other coliform detection. At 8-12 hrs Escherichia coli was detected by fluoregenic quality in UV and at 24 hrs Escherichia coli was detected by chromogenic quality in ambient light. This may be using the naked eye or with the aid of an instrument. (ideally, a control consisting of medium dissolved in sterile water may be used for comparison) Any detected fluorescence in UV usually indicates the presence of E. coli. Any chromogenic quality (e.g. blue), is usually indicative of other coliforms than E. coli.)

An aspect of this invention is use of a fluorogenic substrate providing a slow fluorescent quality with a solid assay. (reference photos previously submitted with original application—Photos #1-9) Some types of dual enzyme substrates are an example. They can be used to produce a fluorescent quality that tends to diminish, and a chromogenic quality. An aspect of this invention is the use of these qualities to monitor enzyme activity. For example, a first “bullseye” stage, fluorescent quality stage mainly alone may indicate that the reaction has recently or just started. A second stage, chromogenic quality concomitant with fluorescent quality may indicate that the reaction started some time ago and is most likely still occurring. (see Set II photos d & e) A third stage, chromogenic quality mainly alone may indicate that the reaction has occurred. Such technique can be applied to various assays or inhibitor studies to show any inhibition of fluorogenic quality diminished or absent with or without chromogenic quality, such as microbiological media, enzyme kinetics, or cancer assays to monitor specific enzyme activity.

Applications of this technique are virtually unlimited. For instance, a dual or duogenic method may use the detection of a stage of a “bulls-eye” during the formation of a CFU (colony forming unit) of many types of microbes a with a solid growth medium. (See Set II photo b, Set III photo b of bulls-eye stage effect) The stages can occur when using at least one type of substrate such as 6-chloro-3-indolyl-beta-D-galactoside. This can indicate one or more of the following: differentiation of different strains or species, differentiation of stressed or injured cells of the same species, or differentiation of different strains of the same species or genus.

Cell or microbe aggregations (CFUs) often may form circular colonies, with the oldest part of the colony often being the central area with the more actively growing portion constituting the edge area.

An important aspect of the “bulls eye” stages of items method is that it may allow detection differentiation and identification of different strains or species or genus of tissues/cells or microbes or stressed or injured cells each of which tends to have their own characteristic enzyme activity/growth/reproduction rate by the application of principles this invention. Any non-target debris present in a sample such as but not limited to meat or cheese that may have enzyme activity may show up as an irregular shape which may differentiate it from a more circular bullseye microbial colony(s). This can facilitate the early identification and quantification of the different target items from non-target materials. (see Set II photo b).

The teaching in the art (e.g.—by Brenner) has been “if two chromogens are used, two different contrasting-color chromophores should be produced upon specific enzyme cleavage, and a third distinct color should be produced by the presence of both colors in the colonies of organisms that have both enzymes . . . if two fluorogens are used, the two compounds should have considerably different excitation and emission wavelengths to be easily distinguished from one another.” As an aspect of the invention it has been found that two or more indicator substrates can be used that produce the same wavelength quality and be differentiated by wavelength intensity or size of CFUs, or growth rates of organism types/conditions. Teaching has been against the use of chromogenic/fluorogenic substrates producing a fast quality. “Upon cleavage, chromogens should produce insoluble or only slightly soluble chromophores that will remain localized in the bacterial colonized. Similarly, fluorophores should not diffuse away from the colonies, as excessive diffusion hinders target colony recognition, discrimination, and enumeration.” (e.g.—Brenner patents) Also, Manafi teaches that “the disadvantage of incorporating MUG in agar is that fluorescence diffuses rapidly into the surrounding agar substrate and therefore the plates have to be read after overnight incubation usually. Several attempts have been made to simultaneously detect coliforms and E. coli in water, using o-nitrophenyl-B-D-galactopyranoside (ONPG) and MUG (Edberg et al., 1988, 1989, 1990). However, it was observed that also chromogenic nitrophenolic substances such as ONPG or p-nitrophenol-B-D-glucuronide (PNPG) diffuse easily through solid media. Therefore, these substrates cannot be used in solid media.” (Manafi, 1991) Bascomb and Manafi, 1991, defines overnight incubation as requiring as much as 24 h, “ . . . this adds an overnight incubation period to the duration of the test. Therefore, the so-called 15-minute test in reality may require 24 h”. (Manafi, 1991) In contrast, with the present invention it has been found that when using fluorogenic substrates producing a fast fluorescent quality, (often contrasting for more than one quality) various sones (e.g.—di-fluoroscein B-D galactoside, and MUGluc) were used alone to detect separate coliform CFUs in 12 hrs and it is obvious that they can work together for detection and differentiation of enzyme activity achieved earlier than 18-24 hr by eye or with instrumentation with a solid or liquid assay.

ONPG can detect and quantify coliforms in a solid assay.

N-methyl-B-galactoside and MUgluc can detect E. coli and Enterobacter by 19 hrs.

6-chloro-3-indolyl-B-glucuronide was used to detect E. coli by a dual and a slow fluorescent quality in 1 ml water using an aerobic Petrifilm™ brand device from 3m corporation, showing the versatility of an aspect of the invention.

Ph indicators and sugars are expected to work with the invention.

The same or different substrates can be used, e.g., Mugal and Mugluc together, for each method above, differentiated by the comparison of intensities of the one or more fluorogenic and chromogenic qualities. At early stages, observation or images taken of an assay at different times by instrumentation and/or the naked eye can be used to obtain diagnostics e.g., quantification and qualification of injured organisms, and other details.

It is known in the prior microbial assay art that current methods for detection and/or differentiation detecting fungi can often involve a long growth and incubation period, typically 18-72 hrs or more as growth may be much slower than the growth common to many bacterial entities. The initial entity (germling) produced by the germination of the mold spore is often very small, and is often not or barely detectable to the eye within a 24 hr period. However, unpublished work for this invention with various molds using indicator enzyme substrates producing a fast or slow color quality, indicate that early detection identification and enumeration may be achieved at different stages of growth. (see Set V photos) Fluorogenic enzyme substrates(s) may be used for detection of spore(s) or the resulting colony(s) in UV light at or less than 24 hr. It is thought that Chromogenic and Fluorogenic tetrazolium salts may sometimes also be used to rapidly detect fungi.

The use of one or a combination of indicator enzyme substrates, e.g., indicator enzyme substrates producing a fast/slow quality in a single assay e.g., medium, may not only result in the rapid detection of molds, but may also result in the differentiation of various types or species of molds and mold tissues, hyphae or spores, depending on different enzyme profiles that each mold, spore, and hyphal type possesses. The rate that different types of mold grow and varying times and amounts in which different enzymes may be produced can also be factors in the detection and differentiation of different mold species or types.

Phosphate, B-glucoside and acetylgalactosamide based substrates may be

used as general fungi detectors. This is thought to be the first described method using a fluorogenic substrate for rapid detection and identification of mold and is an embodiment of this invention. Any inhibitor that can sufficiently suppress non-target entities but ideally not significantly suppress target fungal and any other target entities may be used and penicillin is an example. Combinations of mold and other microbes may be detected and differentiated in one assay with this method.

Examples completed for Mold:

### Example 16

a. A Basal Medium was made comprising the following ratio of ingredients. Deionized water (1 liter), Peptone (5 g./L), Yeast Extract (3 g./L) and Potato Extract (3 g./L). Three different media formulations were used by the addition of three different enzyme substrates to each of one aliquot of the basal medium.

The steps of use being:
a. The enzyme substrate. 6-chloro-3-indolyl-B-phosphate (180 mg/L) was added into one aliquot of the Basal Medium to achieve a first Medium, the enzyme substrate MUB-glucoside (100 mg/L) was added into a second aliquot of the Basal medium to achieve a second Medium, and the enzyme substrate MUB-galactoside (100 mg/L) was added into a third aliquot of the basal medium to achieve a third Medium.
b. About 2 ml of each medium was added to a separate absorbent pad in separate petri dishes, and a micropore membrane was placed on each pad. (The above media with a gelling agent may work too, (e.g.—on or in agar or Easygel® and petri dish with hardener coating.)
c. Mold (e.g.—spores and/or hyphal fragments) was then contacted with the test surface and the container was closed.
d. This container was incubated at 25-30° C.)
e. Mold growth was detected by fluorescent quality in 24-36 hrs or less. (see Set V photos) Detect results by instrument use (e.g.—photography, colony counter, or the naked eye).

For this invention it is thought speed of target item detection and/or target item detection may be enhanced by promoting access of the substrate into a target entity and/or contact to a target enzyme. In a microbial assay, agents that permeate or induce permeability to the membrane of bacteria may be used to promote access of any substrate to an enzyme and/or to the inside of the bacteria to an enzyme. According to Vaara, certain previously known materials may work, and they include cationic agents such as Polymyxin, Polymyxin nonapeptides, and others, though Polymyxin nonapeptides aren't usually lethal.

Luminescent enzyme substrates have been used to shorten detection time to 6.5 hours, but often requires three steps and x-ray usage, and may destroy the detected target items and tends to give high false negative counts. (Van Poucke, Nelis 1995) They usually used two or more steps; inoculating growth media on solid bases with a membrane, transferring membrane to either 1. a fluorogenic substrate producing a fast fluorescent quality, or 2. to a luminogenic substrate agent and polymyxin and transferring the membrane to a fluorescent dye. Just one bacterium type was tested for using one indicator enzyme substrate, with or without extra fluorescent dye. Van Poucke teaches that medium ingredients, such as yeast extracts, peptones, and others, can cause background fluorescence, making it harder to detect the substrate/enzyme reaction produced fluorescence. It has been recognized as an aspect of this invention that this can be true for chromogenic substrates too. Van Poucke (1997) concludes “This study presents evidence for the unfeasibility of enzymatic presence-absence tests to detect one total coliform or one Escherichia coli organism in 100 ml of drinking water within a working day. The results of field trials with prototype chemiluminometric procedures indicated that the sensitivity-boosting measures that are essential to achieve the required speed compromise the specificity of the tests.”. However, through the present invention, it has been found that when using indicator substrate(s) with some detection enhancing factor(s), one total coliform (one E. coli) CFU, or, it is thought, some other organisms, may be detected within one 8 hr working day time.

Following Paragraphs Address Further Aspects of the Invention

There are ingredients commercially available and reputed as inducers, or enzyme inducers, which may be used in this invention. In prior art, Isopropyl-B-D-thio-galactopyranoside, (IPTG) has been used as an inducer to enhance detection of enzyme(s) when using different B-galactosidase indicator substrates. It is thought that many ingredients may serve as an enzyme inducer, including indicator substrates (e.g.—chromogenic and fluorogenic substrates which may include dual enzyme substrates). It is thought examples may include different isopropyl thio glycosides and methyl-O-glycosides for corresponding glycoside substrates (e.g. 6-chloro-3-indolyl-B-D-galactoside). In addition, inducers may be used in media without chromogenic or fluorogenic substrates. Sugars such as lactose have been used as intended inducers, though the efficacy is doubted in some cases. It is thought by some that heat may be an inducer.

Virtually any inhibitor of non-target items may be used with this invention. Inhibitors can include antibiotics, (e.g.—cefsulodin (may harm coliforms) and penicillin), bile salts and related compounds (e.g.-sodium deoxycholate, sodium lauryl sulfate), and various surfactants (e.g. Tergitol-7).

It was found that amounts of some ingredients in an assay may be minimized to encourage some target organisms to utilize specific enzyme substrates and/or other ingredients.

Sugars such as but not limited to them sorbitol, maltose, mannitol, melibiose and others and compounds such as sodium pyruvate (or pyruvic acid) may be used with methods of the invention to resuscitate, promote repair and enhance detection of some target items. These materials may be used in amounts of 500 mg-3 grams/liter of medium. Temperature may be used too, as appropriate in a given application. Methods of the invention may include use of a separate resuscitation/preincubation step to improve detection of some items such as microbes.

Most probable number tests may be used to determine probable final counts for different assays with systems that can be devised to detect early count results. A reference system may be made (e.g.—with a membrane filter microbial assay) to use early detected identification and counts at various incubation times and temperatures and other conditions to predict probable counts using actual predetermined probable count correlations for various samples.

The present invention may use, but does not require a photomultiplier, a viable microorganism, or an enzyme substrate that should be enzymatically capable of reacting with most organisms.

### DEFINITIONS OF TERMS

1. Assay—an object and/or action that may allow for one or more of analysis, maintenance, or growth of a specific component.
2. Solid Assay (Test)—An assay performed or conducted with, or is made with a base matrix such as tissue, a gel, membrane, or other support.
3. Dual Substrate (Duogen).—An enzyme substrate that due to enzyme reaction allows for two or more distinctive color qualities indicative of the same enzyme reaction.
4. NF Substrate—An enzyme substrate that due to enzyme reaction allows for a fluorescent quality that can be detected. The quality is one expected from not very diffusing, or precipitating products in aqueous environments.

### REFERENCES

Van Ommen Kloeke, et al. “Localization and Identification of Populations of Phosphatase-Active Bacterial Cells Associated with Activated Sludge Flocs” Microb Ecol (1999) 38: 201-214
Van Ommen Kloeke, et al. “Novel method for screening bacterial colonies for phosphatase activity” Journal of Microbiological Methods 38 (1999) 25-31 5316906 Haugland
Manafi, M., et al. “Fluorogenic and Chromogenic Substrates Used in Bacterial Diagnostics” Microbiological Reviews, September 1991, 335-348
Manafi, M. et al, “A new plate medium for rapid presumptive identification and differentiation of Enterobacteriaceae” July 1991

Although the present invention has been described above in detail, the same is by way of illustration and example only. Those skilled in the relevant art will now understand from this disclosure that, for example, each and every “aspect” of the present invention is not required to be used in every application of the present invention and that various modifications based upon the examples and aspects stated are contemplated by this invention. Accordingly, the spirit and scope of the present invention are limited only by the terms of the following claims.

What is claimed is:

1. A method of detecting an enzyme, comprising the steps of:
obtaining a sample;
contacting said sample with a dual enzyme substrate diagnostic material that can provide for at least a fluorogenic and chromogenic quality due to enzyme reaction in said sample; and
monitoring the result of said contacting to detect at least the presence or absence of chromogenic quality representing said enzyme reaction; and
monitoring the result of said contacting to detect at least the presence or absence of fluorogenic quality representings said enzyme reaction.

2. The method according to claim 1 wherein the dual enzyme substrate is an indolyl-based substrate.

3. A method of detecting an enzyme, comprising the steps of:
a. obtaining a sample;
b. contacting said sample with a dual enzyme substrate diagnostic material that can provide for at least any combination of two or more fluorogenic or chromogenic qualities due to enzyme reaction in said sample; and
c. monitoring the result of step b to detect at least the presence or absence of chromogenic qualities representing a product diagnostic of said enzyme reaction; and
d. monitoring the result of step b to detect at least the presence or absence of fluorogenic qualities representing said enzyme reaction.

4. The method according to claim 1 where the dual enzyme substrate is chosen from indolyl, resorufin, and fluorescein based substrates.

5. A medium comprising a dual enzyme substrate diagnostic material having at least any combination of two or more fluorogenic or chromogenic qualities

6. A method of detecting an enzyme comprising the steps:
a. obtaining a sample;
b. contacting said sample with an enzyme substrate diagnostic material that can provide for at least a slow diffusing, non diffusing or precipitating fluorogenic quality for a solid test due to enzyme reaction in said sample; and;
c. monitoring the result of step b to detect at least the presence or absence of any slow diffusing fluorogenic quality representing said enzyme reaction.

7. A medium comprising an enzyme substrate diagnostic material having at least a slow diffusing, non diffusing or precipitating fluorogenic quality.

8. A method of detecting an enzyme, comprising the steps of:
a. obtaining a sample;
b. contacting said sample with an indolyl based enzyme substrate diagnostic material that can provide for at least a slow diffusing, non diffusing or precipitating fluorogenic quality for a solid test due to any enzyme reaction in the presence of any target enzyme in or produced by items in said sample; and
c. monitoring the result of said contacting to detect at least the presence or absence of any slow diffusing, non diffusing or precipitating fluorogenic quality representing any said enzyme reaction.

9. A medium comprising an indolyl based enzyme substrate diagnostic material having at least a slow diffusing, non diffusing or precipitating fluorogenic quality.

10. A method of detecting an enzyme, comprising the steps of:
obtaining a sample;
contacting said sample with a dual enzyme indolyl based substrate diagnostic material that can provide for at least a fluorogenic and chromogenic quality due to any enzyme reaction in the presence of any target enzyme in or produced by items in said sample; and
monitoring the result of said contacting to detect at least the presence or absence of any chromogenic quality representing any said enzyme reaction; and
monitoring the result of said contacting to detect at least the presence or absence of any fluorogenic quality representings any said enzyme reaction.

11. A method of detecting an enzyme, comprising the steps of:
obtaining a sample;
contacting said sample with an enzyme indolyl based substrate diagnostic material that can provide for at least a combination of two or more fluorogenic qualities due to enzyme reactions from at least two different substrates in said sample; and
monitoring the result of the preceeding step to detect at least the presence or absence of chromogenic qualities representing a product diagnostic of said enzyme reaction; and
monitoring the result of said preceeding step to detect at least the presence or absence of any fluorogenic qualities representing any said enzyme reaction.

12. A medium comprising a dual enzyme indolyl based substrate diagnostic material having at least any combination of two or more fluorogenic or chromogenic qualities.

13. A medium comprising a dual enzyme indolyl based substrate diagnostic material having at least a fluorogenic and chromogenic quality.

14. The invention according to claim 1 where the fluorescent quality dissipates, detecting said enzyme.

15. The invention according to claim 3 where the fluorescent quality dissipates, detecting said enzyme.

16. The invention according to claim 14 where the fluorescent quality is primarily detected before the chromogenic quality that detects past enzyme activity.

17. The invention according to claim 1 where naturally fluorescent organisms are detected by their fluorescence.

18. The invention according to claim 1 where combination of 3-indolyl and N-methyl-3-indolyl based substrate provides for a more compact organism appearance.

19. A method of detecting an enzyme, comprising the steps of:
obtaining a sample;
contacting said sample with a enzyme substrate diagnostic material that can provide for at least a fast diffusing fluorogenic or chromogenic quality due to any enzyme reaction in the presence of any target enzyme in or produced by items in said sample; and
monitoring the result of said contacting to detect at least the presence or absence of any fast diffusing chromogenic quality representing any said enzyme reaction; and
monitoring the result of said contacting to detect at least the presence or absence of any fast diffusing fluorogenic quality representing any said enzyme reaction.

20. A method of detecting an enzyme, comprising the steps of:
obtaining a sample;
contacting said sample with at least two different enzyme substrate diagnostic materials that can provide for at least two contrasting fast diffusing fluorogenic or chromogenic quality due to any enzyme reaction in the presence of any one or different target enzymes in or produced by items in said sample; and
monitoring the result of said contacting to detect at least the presence or absence of any fast diffusing chromogenic quality representing any said enzyme reaction; and
monitoring the result of said contacting to detect at least the presence or absence of any fast diffusing fluorogenic quality representing any said enzyme reaction.
